(19) United States
(12) Patent Application Publication
(10) Pub. No.: US 2026/0203394 A1
(43) Pub. Date: Jul. 16, 2026

(54) A METHOD FOR SECURE, SIMPLE, AND FAST SPECULATIVE EXECUTION CROSSING TRUST DOMAINS

(71) Applicant: Purdue Research Foundation, West Lafayette, IN (US)

(72) Inventors: Terani N. VIJAYKUMAR, West Lafayette, IN (US); Mithuna Shamabhat THOTTETHODI, West Lafayette, IN (US); Conor James GREEN, Lafayette, IN (US); Cole Aaron NELSON, West Lafayette, IN (US)

(73) Assignee: Purdue Research Foundation, West Lafayette, IN (US)

(21) Appl. No.: 19/135,368

(22) PCT Filed: Dec. 7, 2023
(86) PCT No.: PCT/US2023/082944

§ 371 Date: Jun. 3, 2025

Related U.S. Application Data
(60) Provisional application No. 63/430,946, filed on Dec. 7, 2022.

(51) Int. Cl. G06F 21/52

(52) U.S. Cl. CPC G06F 21/52; G06F 2221/033

(57) ABSTRACT

A method of verifying the safety of a speculative instruction in a computing environment is disclosed which includes a processor speculatively arriving at execution of an instruction, the instruction associated with i) a source representing a range of source virtual or physical memory addresses holding the instruction to be executed, and ii) a destination representing a ranges of destination virtual or physical memory addresses holding data of which one or more addresses are to be loaded onto a register with execution of the instruction in the source, the source and destination representing a pair of information (PAIR). If the speculation of the source instruction clears the checking the PAIR step as safe, then allowing the execution of the speculative instruction to proceed, and if the speculation of the source instruction does not clear the checking as safe, then execution of the speculative instruction is delayed until such execution becomes non-speculative.

### CROSS-REFERENCE TO RELATED APPLICATIONS

This patent application claims priority to a U.S. provisional patent application S/N 63/430,946 filed Dec. 7, 2022, contents of which are hereby incorporated by reference in its entirety into the present disclosure.

### STATEMENT REGARDING GOVERNMENT FUNDING

None.

### TECHNICAL FIELD

The present disclosure generally relates to speculative execution of modern processors, and in particular, to a method of securely carrying out speculative execution.

### BACKGROUND

This section introduces aspects that may help facilitate a better understanding of the disclosure. Accordingly, these statements are to be read in this light and are not to be understood as admissions about what is or is not prior art.

For some time now, microprocessor speeds have grown faster than memory speed. Despite many optimizations to reduce the impact of the speed gap, it remains true that the time spent by microprocessors waiting for memory accounts for a significant fraction of execution time.

In order to remedy the aforementioned challenge, for several years now, microprocessor designers have used speculative execution. In a typical speculative execution, a processor may be waiting for memory to supply the data for one instruction which may feed data to the next instruction which uses the data to conditionally branch to one of multiple possible execution paths. In doing so, the processor predicts the branching outcome of the second instruction prior to the completion of the first instruction and proceeds to speculatively execute instructions in the predicted path. In this manner, the processor does not have to remain idle until the execution of the first instruction is complete prior to starting execution of the conditional branch, thereby improving the performance of the processor. Once the execution of the first instruction is complete, one of two outcomes are possible. If the result of the execution reveals that the prediction was correct, all the work done speculatively is now considered non-speculative and the resulting execution is accepted. If however, the execution reveals that the prediction was incorrect, the processor returns to the point where the conditional branch execution began and thus discards all data associated with that mispredicted execution by cleaning up registers.

Speculative execution based processers are nowadays commonplace. As a result, security attacks have also become commonplace. Speculative execution-based security attacks, also referred to as Meltdown and Spectre attacks, affect most modern computer systems which include high-performance microprocessors that utilize speculative execution. These attacks includes hardware-based attacks which can read the entire kernel or browser memory at viable transmission rates (e.g., hundreds of KB/s). While many software-based attacks exist (e.g., buffer overflow), these hardware-based attacks have become significantly more. Since the attacks were revealed, several variants have appeared and more are likely to come on to the scene.

Generally, these hardware-based attacks exploit speculative execution based on the facts that (1) incorrect execution before mis-speculation detection can be leveraged to access transient secrets that are otherwise inaccessible even within the same process, and (2) upon detecting mis-speculation, modern architectures clean up the architectural state, as discussed above (e.g., by rewriting register and memory) but not the micro-architectural state (e.g., branch predictors and caches). The surviving micro-architectural state can act as a side channel that can transmit information with deleterious effect.

To date, the Spectre attacks have three variants with many sub-variants. The first variant (CVE-2017-5753) circumvents software bounds-checking by exploiting branch prediction to transiently load forbidden data (e.g., JavaScript transiently loading the Web browser's data). The second variant (CVE-2017-5715) injects indirect branch target (or return address) from the attack process to exploit a gadget (i.e., an attacker-selected code snippet) in a victim process to transiently load forbidden data (e.g., a user process fooling the kernel). The final variant (CVE-2018-3639), known as Spectre-v4, exploits speculative store bypass. Unlike the first two variants, the third has not been shown to be practical.

Another Spectre attack variant that can potentially abuse software control permissions is also possible. This variant exploits control-flow speculation to fool a gadget in victim code into transiently accessing forbidden data in one dynamic execution context that the gadget had accessed non-speculatively in the past in another context. For example, a browser-tab shared utility function (i.e., a gadget) called from the browser may acquire permissions to the browser data which could be abused by a malicious tab to access the data via the same function. This variant represents a dynamic execution context-based behavior that can be potentially exploited by a malicious tab to gain access to historical non-speculative accesses.

Some Meltdown variants are Intel-specific, wherein the data of homonyms are speculatively forwarded, which can then be leaked. Some attacks forward data based on just partial address matches. The root of the problem is Intel's lazy checking of the TLB or not checking at all upon TLB misses while speculatively supplying the data across protection domains. Non-Intel architectures perform eager checking and do not speculate past TLB misses, and this do not suffer from this security vulnerability.

Several approaches have been implemented to address hardware-based speculative execution-style attacks. Approaches to plug the transmissions must cover all channels which is more difficult than preventing the forbidden access. In fact, rolling-back micro-architectural state to plug the transmission may be susceptible to timing channels. Various other proposals plug specific side channels but make invasive hardware changes (e.g., changes to cache coherence), incur performance loss, may transmit value-predicted secrets, or remain susceptible to other side channels be discovered later. Still other proposals allow the unsafe access but block all side channels by preventing the transmission of the secrets via delaying the secret-dependent instructions until they are no longer speculative. However, these schemes require complex hardware or incur high performance loss.

Therefore, there is an unmet need for a novel approach to address hardware-based attacks on architectures that operate using speculative execution.

### SUMMARY

A method of verifying the safety of a speculative instruction in a computing environment is disclosed. The method includes a processor speculatively arriving at execution of an instruction, the instruction associated with i) a source representing a range of source virtual or physical memory addresses holding the instruction to be executed, and ii) a destination representing a ranges of destination virtual or physical memory addresses holding data of which one or more addresses are to be loaded onto a register with execution of the instruction in the source, the source and destination representing a pair of information (PAIR), during instruction execution checking the PAIR against one or more memory tables associated with previous combinations of the PAIR that have successfully cleared as non-speculative, maintaining the one or more tables in a safe state. If the speculation of the source instruction clears the checking the PAIR step as safe, then the method includes allowing the execution of the speculative instruction to proceed, and if the speculation of the source instruction does not clear the checking as safe, then execution of the speculative instruction is delayed until such execution becomes non-speculative.

According to one embodiment of the method, the PAIR in the one or more tables includes source and destination identifiers.

According to one embodiment of the method, the instruction in the source includes a load instruction.

According to one embodiment of the method, the source represents a first region.

According to one embodiment of the method, the destination represents a second range of virtual or physical addresses.

According to one embodiment of the method, the step of maintaining the one or more tables in the safe state includes clearing all entries in the one or more tables whenever a speculative inter-region control-flow transfer instruction is encountered.

According to one embodiment of the method, the inter-region control transfer instruction includes one or more of a branch, jump, call, return instruction that starts in the first region and transfers control to the second region by changing a program counter.

According to one embodiment of the method, when the execution of the speculative instruction becomes non-speculative, the one or more tables are updated to include the PAIR as having successfully cleared as non-speculative source-destination two-tuples.

According to one embodiment of the method, an instance identifier is associated with the instruction and the one or more tables include instance identifier-destination ID two-tuples.

According to one embodiment of the method, the instruction includes a load instruction.

According to one embodiment of the method, the source represents a first region.

According to one embodiment of the method, the destination represents a second range of virtual or physical addresses.

According to one embodiment of the method, the step of maintaining the one or more tables in the safe state includes assigning a value associated with an instance counter to an instruction instance variable followed by incrementing the instance counter whenever a speculative inter-region control transfer instruction is encountered

According to one embodiment of the method, the inter-region control transfer instruction includes one or more of a branch, jump, call, return instruction that starts in the first region and transfers control to the second region by changing a program counter.

According to one embodiment of the method, when the execution of the speculative instruction becomes non-speculative, the one or more tables are updated to include the instance identifier-destination two-tuples as having successfully cleared as non-speculative.

According to one embodiment of the method, an instance stack is pushed with the instance identifier of an inter-region call instruction upon an associated commit and the instance stack is popped when an inter-region return instruction commits, wherein an inter-region control transfer instruction includes one or more of a branch, jump, call, return instruction that starts in the first region and transfers control to the second region by changing a program counter.

According to one embodiment of the method, the step of maintaining the one or more tables in the safe state includes assigning a current instance variable to an instruction instance variable followed by incrementing an instance counter whenever a speculative inter-region control transfer instruction is encountered and assigning the instance counter to the current instance variable.

According to one embodiment of the method, i) an instruction of a callee, which is an owner, and ii) the instruction's instance identifier matches that on the instance stack at a top of stack (TOS), the instruction inherits the associated caller's instance identifier-destination ID two-tuples in the one or more tables by using the caller's instance identifier on the instance stack at one level below the top of stack (1LBTOS).

According to one embodiment of the method, a caller's instructions, upon execution returning from a callee which is an owner, retain the caller's own previous instance identifier on the instance stack by first popping the instance stack for the return and then assigning the current instance variable to top of stack (TOS).

According to one embodiment of the method, when the execution of the speculative instruction becomes non-speculative, the one or more tables are updated to include the instruction's instance identifier-destination two-tuples as having successfully cleared as non-speculative.

According to one embodiment of the method, i) when a speculative inter-region call instruction is encountered, an instance counter is incremented and assigned to a current instance variable which is then pushed on an instance stack, and ii) when a speculative inter-region return instruction is encountered, the instance stack is popped and top of stack (TOS) is assigned to the current instance variable, wherein an inter-region control transfer instruction includes one or more of a branch, jump, call, return instruction that starts in a first region and transfers control to a second region by changing a program counter.

According to one embodiment of the method, the step of maintaining the one or more tables in the safe state includes assigning the current instance variable to an instruction instance variable followed by incrementing the instance counter whenever a speculative inter-region control transfer instruction is encountered and assigning the instance counter to the current instance variable.

According to one embodiment of the method, a set of inter-region control-flow transfer instructions' identifiers associated with each such instruction's reorder buffer entry (Specset) is maintained in hardware by i) inserting a reorder buffer identifier into the Specset upon encountering such a speculative instruction and ii) deleting the reorder buffer identifier when the instruction either commits or is squashed due to a misspeculation.

According to one embodiment of the method, upon a misspeculation squash, if any of the reorder buffer identifiers associated with the squashed instructions is in the Specset then the instance stack is cleared and the instance counter is incremented and is assigned to the current instance variable.

According to one embodiment of the method, i) an instruction of a callee which is an owner and ii) the instruction's instance identifier matches that on the instance stack TOS, the instruction inherits the associated caller's instance identifier-destination ID two-tuples in the one or more tables using the caller's instance identifier on the instance stack at one level below top of stack (1LBTOS).

According to one embodiment of the method, when execution returns from a callee which is an owner, a caller retains the caller's own previous instance identifier on the instance stack by first popping the instance stack upon the return and then assigning the current instance variable to the TOS.

According to one embodiment of the method, when the execution of the speculative instruction becomes non-speculative, the one or more tables are updated to include the instruction instance identifier-destination two-tuples as having successfully cleared as non-speculative.

According to one embodiment of the method, a set of snapshots (copies) of the instance stack at various points in time of execution (Checkpoints) is maintained in hardware by i) inserting the snapshots into Checkpoint upon encountering a speculative inter-region control-flow transfer instruction and associating the snapshot with the reorder buffer entry number of the instruction, and ii) deleting the associated snapshot when the instruction either commits or is squashed due to a misspeculation.

According to one embodiment of the method, upon a misspeculation squash, i) if the oldest squashed reorder buffer entry has an associated snapshot in the Checkpoint, then the instance stack is overwritten with (restored by) the snapshot and the current instance variable is set to the restored TOS, and ii) If not, the instance stack is cleared, and the instance counter is incremented and assigned to the current instance variable.

According to one embodiment of the method, i) an instruction of a callee which is an owner, and ii) the instruction's instance identifier matches that on the instance stack TOS, the instruction inherits the associated caller's instance identifier-destination ID two-tuples in the one or more tables by using the caller's instance identifier on the instance stack at one level below top of stack (1LBTOS).

According to one embodiment of the method, a caller's instructions, upon execution returning from a callee which is an owner, retain the caller's own previous instance identifier on the instance stack by first popping the instance stack upon the return and then assigning the current instance variable to the TOS.

According to one embodiment of the method, when the execution of the speculative instruction becomes non-speculative, the one or more tables are updated to include the instruction instance identifier-destination two-tuples as having successfully cleared as non-speculative.

### BRIEF DESCRIPTION OF DRAWINGS

FIG. 1 is a schematic of an out-of-order issue pipeline with a SafeBet table Speculative Memory Access Control Table (SMACT).

FIG. 2 is a schematic of the SMACT with destination bit mask, the destination matches two entries within the accessed set in the 2-way set associative SMACT but the source matches only one entry.

FIG. 3 is a flowchart based on the method of the present disclosure.

FIG. 4 is a flowchart which provides one example of how the speculative execution works, according to the present disclosure.

FIG. 5 is an example schematic of regions with calls and instances, according to the present disclosure.

FIG. 6 is a schematic showing how one entity inherits another entity's permissions.

FIG. 7 is a schematic exemplifying implementing instances with inheritance.

FIG. 8a is a flowchart showing a basic embodiment wherein the SMACT contains source ID and destination ID pairs and upon recognizing an inter-region activity, the SMACT is simply flushed.

FIG. 8b is a flowchart which introduces an instance counter with which an instance is assigned to an inter-region caller-callee activity.

FIG. 8c is a flowchart which shows how not only an instance counter (with an instance ID) is utilized but also how an instance stack is implemented (the stack is a last-in-first-out array that houses instances and region pairs).

FIG. 8d is a flowchart similar to the flowchart in FIG. 8c where the processor at any point in the pipeline shown in FIG. 1 between instruction decode and dispatch assigns the current instance, the 1LBTOS to every instruction's instance and 1LB.entry, respectively.

FIG. 8e is a flowchart similar to the flowchart shown in FIG. 8c but in addition placing new instance with stack into a Current instance variable.

FIG. 9a is a flowchart showing how to handle at cache access in combination with the embodiment shown in FIG. 8c in which the instance stack for handling inter-region activity is updated at commit).

FIG. 9b is a flowchart showing the at-cache-access embodiment for FIGS. 8d and 8e where the instance stack is updated speculatively.

FIG. 10 is a table providing a SMACT entry containing the destination tag, the instanceID, and the destination bit mask.

### DETAILED DESCRIPTION

For the purposes of promoting an understanding of the principles of the present disclosure, reference will now be made to the embodiments illustrated in the drawings, and specific language will be used to describe the same. It will nevertheless be understood that no limitation of the scope of this disclosure is thereby intended.

In the present disclosure, the term “about” can allow for a degree of variability in a value or range, for example, within 10%, within 5%, or within 1% of a stated value or of a stated limit of a range.

In the present disclosure, the term “substantially” can allow for a degree of variability in a value or range, for example, within 90%, within 95%, or within 99% of a stated value or of a stated limit of a range.

A novel approach referred to herein as SafeBet (the method of the present disclosure) is provided to address hardware-based attacks on architectures that operate using speculative execution. Towards this end, a methodology is described herein which allows only safe accesses based on the key observation that speculatively accessing a location for data access or instruction fetch is safe if the location has been accessed previously non-speculatively by the same instruction (i.e., the instruction is permitted to access the location). As such the present disclosure is directed to improving the functioning of a computer or other technology or technological field such as memory access in a computer. A source instruction is also referred to herein as a source micro-op, as known to a person having ordinary skill in the art. Otherwise, the speculative access is deemed as potentially unsafe. The present disclosure describes a methodology which employs a Speculative Memory Access Control Table (SMACT) which tracks non-speculative source instruction-destination location pairs to check every speculative access for safety. While the permitted accesses proceed as usual, disallowed accesses wait until reaching commit to trigger replay without any intrusive hardware changes. SafeBet exploits redundancy in the upper-order bits of source and destination addresses to reduce the table sizes via a bit mask representation. To achieve larger effective table capacity, SafeBet safely coarsens the source and destination granularity. Finally, the permissions are revoked when the source or destination memory is freed to prevent unsafe use of stale permissions. To avoid cache coherence-like complexity, SafeBet performs the revocations in software whose overhead is amortized by lazily batching several frees. SafeBet achieves this security using only simple table-based access control and replay with virtually no change to the pipeline. Software simulations show that SafeBet uses 18 KB per core for the tables to perform within 6% on average (62% at worst) of the unsafe baseline behind which non-speculative data access (NDA)-restrictive, a previous scheme of comparable (a) security and (b) hardware complexity, lags by 83% on average.

SafeBet allows only safe accesses, thereby preventing transmission of secrets. As mentioned above, SafeBet is based on a key observation that speculatively accessing a location is safe if the location has been accessed previously non-speculatively by the same instruction (i.e., the instruction is permitted to access the location). The instruction is referred to as source and the location is referred to as the destination. The permission is per source instruction because some destinations are forbidden for some sources within the same process in some attack scenarios (e.g., the browser data is forbidden for the tabs within the browser process). A data access or an instruction fetch that is deemed potentially unsafe can proceed only upon reaching commit. Thus, while no unsafe access or fetch (false positive) is allowed, some safe accesses or fetches may be delayed (false negative), thereby resulting in some performance loss.

SafeBet employs the following schemes: First to track non-speculative data access and instruction fetch source-destination pairs, respectively, Speculative Memory Access Control Table (SMACT) is added to the existing microprocessor architectures. While the permissions are created in the tables upon the source reaching commit, speculative sources look up the SMACT in parallel with the Data Translation Lookaside buffer (DTLB) and the data cache. Disallowed accesses and fetches wait until the source instruction reaches commit. Alternately, waiting only until the access or fetch becomes non-speculative achieves a shorter delay which is important when all accesses are delayed, however, this approach requires complex hardware changes. Because SafeBet's false negative rates, mainly due to misses in the tables, are low, SafeBet employs the simpler choice by leveraging the well-known replay scheme for cache misses. Second, to shrink the size, Branch Target Buffer (BTB) of a microprocessor architecture often uses fewer bits than needed for the source and destination addresses. However, such compression in the SMACT would induce potentially unsafe aliases where the permissions of a source-destination pair would be inherited by other aliases. As such, using all the source and destination address bits avoids any aliasing, but does incur overhead. According to one embodiment of the present disclosure, these overheads are reduced by exploiting the redundancy in the upper-order address bits of the sources and destinations via a two-level organization for the tables, so that many first-level entries (lower-order bits) share a second-level entry (upper-order bits), implemented via bit masks. Third, to increase the effective capacity and decrease the false-negative rates of SafeBet's tables, the method of the present disclosure according to one embodiment, coarsen the granularity of the source and destination. Coarsening the source to a granularity (e.g., GB) is safe if the code and static data from various trust domains (e.g., user code, libraries either together or in subsets, browser, and kernel) are placed at boundaries aligned to the granularity. However, coarsening the destination to a granularity while avoiding aliases requires that the minimum size for dynamic memory allocation be the granularity (e.g., no larger than 32-64 B to avoid internal fragmentation). Fourth, a source-destination pair's permission must be revoked when the source or destination memory is freed; otherwise, a stale permission could be used to access illegally a freed destination that is later reallocated. Hardware invalidations for such revocations in a multicore processor system may incur cache coherence-like complexity. Instead, the method of the present disclosure employs software revocations, similar to TLB shootdowns. To amortize the software overhead imposed by frequent freeing, the method batches lazily several frees in one handler invocation based on the key observation that any frequent freeing in applications is typically of small chunks of memory (e.g., 64-128 B). Consequently, the delayed reclamations due to the batching does not significantly impact memory footprint or performance.

To address the exploitation of loophole, SafeBet annotates the source address of every data access with a unique instance identifier so that permissions for the same static code in one instance cannot be used in other instances.

To recap, SafeBet first, instead of unsafely accessing the secret and then preventing its transmission, SafeBet permits speculative accesses and fetches only if in the past the source instruction has non-speculatively accessed or fetched the destination location or instruction. This permission is per source instruction (i.e., permission is not granted if the destination was accessed non-speculatively by some other source). Second, the source-destination pairs are held in the SMACT. To keep the hardware simple, potentially unsafe accesses and fetches wait until commit to proceed by leveraging well-known replay for cache misses. Third, optionally, to save space while avoiding aliasing among sources or destinations, SafeBet employs two-level organizations using bit masks to exploit redundancy in the higher order address bits of sources and destinations. Fourth, and also optionally to increase the effective size of tables and decrease false negative rates, SafeBet coarsens the source and destination granularities while enforcing alignment and allocation restrictions in software to prevent unsafe aliasing. Fifth, to revoke the associated permissions when the destination memory is freed, SafeBet employs either hardware invalidation or software invalidation whose overhead is amortized by batching several revocations in software. Sixth, to address dynamic vulnerability (see below), SafeBet annotates the source address of every data access with a unique instance identifier so that permissions for the same static code in one instance cannot be used in other instances.

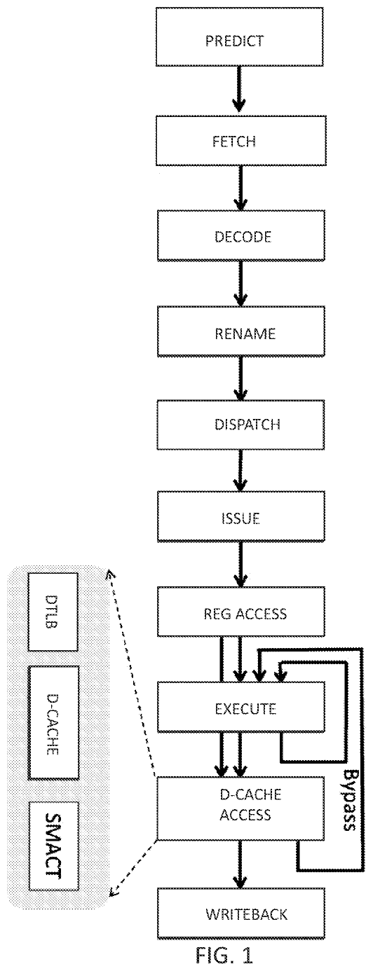

As an initial step speculative data accesses are discussed. Speculative data accesses involve (a) access-control check upon speculative access and (b) delayed execution at commit, if deemed potentially unsafe. For the first part, given the source program counter (PC) and the destination address pair (both virtual addresses), the SMACT is looked up in parallel with the TLB and the data cache, as shown in FIG. 1 which is a schematic of an out-of-order issue pipeline with SafeBet table (SMACT). If the SMACT permits the access (the common case), then the source proceeds as usual (our first two contributions). Otherwise, the source returns a replay signal to the pipeline similar to that for a cache miss. The pipeline annuls the source instruction and in-flight later instructions similar to a cache miss, and marks the source (and later instructions) for replay which occurs when the source reaches commit (i.e., the reorder buffer head).

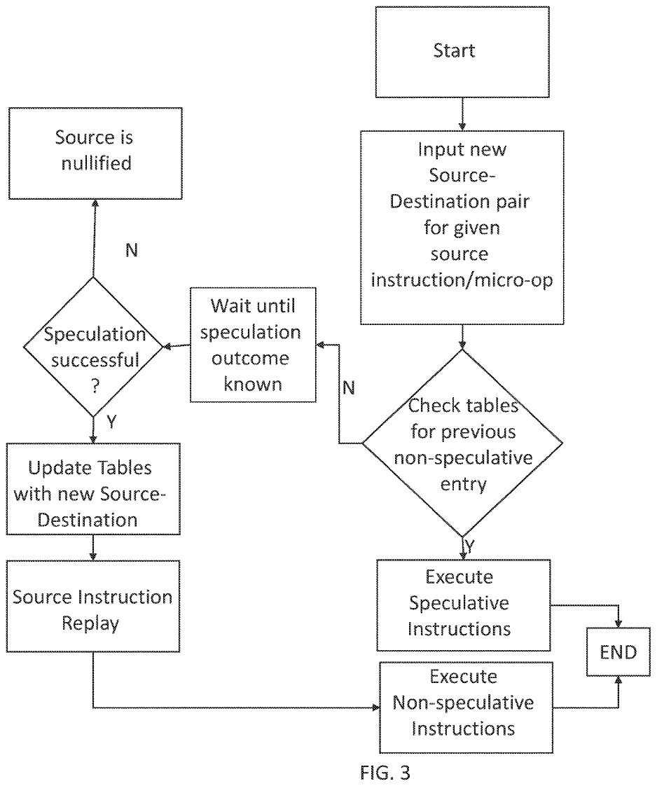

Referring to FIG. 3, a flowchart is presented based on the method of the present disclosure. The flowchart begins by inputting a given source instruction's source-destination pair for examination. These pairs exist in the processor pipeline. The processing of each pair coming from the pipeline is shown in FIG. 3. The examination includes checking table (SMACT) to determine if the source-destination pair has been successfully executed previously which then causes execution for the given source instruction to proceed. If, however, the tables do not determine that the source-destination pair has been successfully executed previously then the source instruction waits for its speculation outcome to be known. If the outcome is success, then the source instruction updates the tables with the source-destination pair and the proceeds to execute. Mechanisms for executing instructions after some waiting include replay. If the outcome is failure, then the source instruction, and potentially other instructions, are nullified.

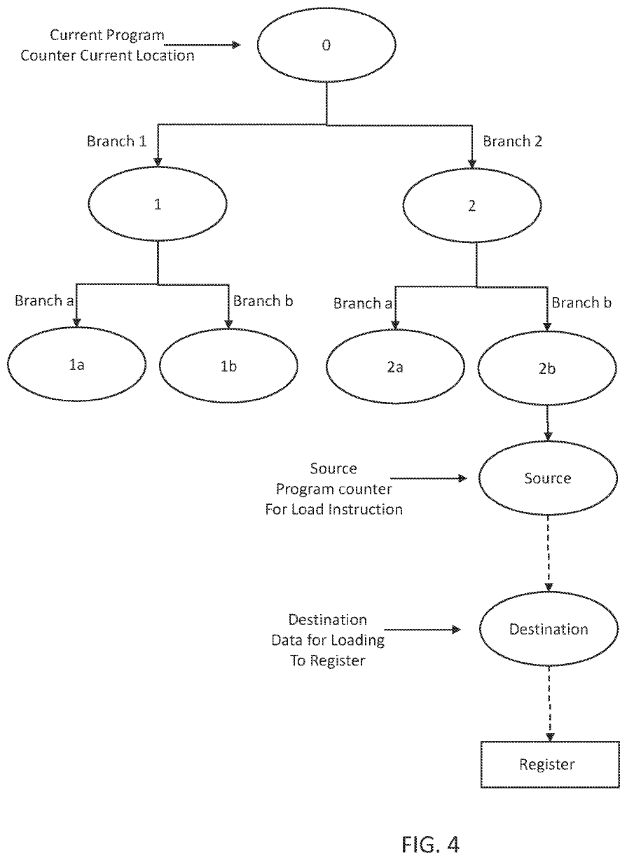

In order to better describe the process of determining if the speculation is successful, e.g., as provided in FIG. 3, the following example is provided with reference to FIG. 4. It should be noted that speculation may be based on a variety of different schemes. For example, speculative execution may be based on branch-speculation (i.e., which branch leads to the instruction for speculative execution is in question). Other examples may include speculation based on output of one instruction feeding another instruction. The present disclosure is agnostic as to the scheme on the basis of which speculation is developed.

With reference to FIG. 4 a flowchart is provided which provides one example of how the speculative execution works according to the present disclosure. The example provided in FIG. 4 is based on branch speculation. Suppose the program counter is currently at location 0. Due to various memory latencies, a scheme for speculative execution speculates that the source-destination pair following path 0→2→2b is to be speculatively executed. Further, suppose the source represents a load instruction (i.e., obtaining a value held at the destination and loading that value onto a register). If the source-destination pair already exists in the SMACT indicating a secure speculative execution, then the processor proceeds with executing the load instruction, speculatively. However, if the source-destination pair is not in the SMACT, then the speculative execution is halted. Instead the instruction pipeline determines if the program execution progresses from 0→2→2b. If not, the pipeline nullifies the load instruction associated with the source-destination pair. If however, the program execution progresses from 0→2→2b and the load instruction in source reaches commit, then the load instruction associated with source-destination pair is actually executed through a replay.

The example shown in FIG. 4 is a mis-speculation based on a branch misprediction. The pipeline determines the branch outcome and flags a mis-speculation if the outcome is not the same as the branch prediction. If a mis-prediction is identified, the pipeline squashes the instructions after the mis-predicted branch is identified; then there are three possibilities for the load: (1) If the load is simply waiting in the pipeline to execute because its operands are not ready, then the pipeline annuls the load instruction and other such instructions. (2) If the load attempted to execute in the past when its operands were ready but was disallowed by the SMACT because the source-destination pair was absent in the SMACT and is now waiting to reach commit, then the pipeline annuls the load instruction and other such instructions. (3) If the load was allowed by the SMACT because the source-destination pair was present and has already executed, then the pipeline rolls back the effects of load and other such instructions. In all these cases, the pipeline resets the reorder buffer (ROB) tail pointer to the mis-predicted branch which is currently the last correct instruction (a mis-predicted branch itself may be correct though the following instructions are incorrect due to the misprediction). Instruction fetch resumes from the correct target.

A cache miss replay occurs when a load or store instruction incurs a miss upon accessing the cache. In the baseline speculative execution (i.e., without SafeBet), the instruction does not exit the pipeline as usual and instead stays in the pipeline until the cache miss returns from the memory hierarchy with the missing cache block which is placed in the cache. At that point, the instruction is replayed—i.e., re-executed—to access the cache again which results in a cache hit. The instruction completes and exits the pipeline (but waits in the ROB until commit or a later squash). SafeBet exploits the replay mechanism for the load instructions whose source-destination pairs are absent in the SMACT. Such load instructions wait until reaching commit. If speculation of all the instructions before a waiting load instruction was correct then the load instruction actually reaches commit (i.e., the head of the ROB), at which point the load instruction updates the SMACT with its source-destination pair and is replayed; otherwise, a mis-speculation has occurred which results in the later instructions including the load instruction being squashed. It should be appreciated that instead of waiting until commit, the replay could be triggered sooner when the source becomes non-speculative. However, detecting this condition requires ensuring that all previous speculations in program order have been resolved, which requires complex hardware. Irrespective of the source waiting until commit or becoming non-speculative, the source and its dependent instructions cannot issue until replay. This constraint decreases the overlap between the miss followed by its dependent instructions, and other independent instructions, degrading instruction and memory-level parallelism. Fortunately, SafeBet incurs this overhead only infrequently (i.e., upon SMACT misses). Consequently, SafeBet can afford the simpler option of the source waiting until commit.

Unlike loads, stores are performed in the cache only upon reaching commit. Therefore, stores can bypass the SMACT even though stores may speculatively prefetch the cache block (including coherence permissions). In fact, even disallowed loads can issue a cache/TLB miss prefetch, and update the cache/TLB replacement metadata. Such a prefetch uses the potential secret's address which is regardless known to the attacker and is not a secret; only a secret's value is a secret. Further, the secret may already be present in memory or even the cache. However, the prefetch places any secret value only in the cache but not the pipeline. The prefetch overlaps the miss, but not the miss-dependent instructions, with the delay until replay. For the above reasons, any software or hardware prefetch can bypass the SMACT. However, unlike prefetches, store-value bypass for matching loads via the load-store queue (LSQ) brings the load value into the pipeline. Therefore, a disallowed load cannot return a bypassed store value and must wait for replay.

For the second part of delayed execution at commit, there are two possibilities: (1) the access was permitted during execution, (2) the access was disallowed and marked for replay. In the former case, there is no further action required. In the latter case, the SMACT is updated with the source-destination pair to create the permission, possibly replacing an existing entry. The source is then replayed similar to a miss and completes. A disallowed source may be squashed due to mis-speculation and may never reach commit in which case the source vanishes from the pipeline without any replay. Further, in uncommon cases a source may already be non-speculative at the time of the access. However, SafeBet performs the SMACT lookup as if the instruction were speculative to avoid the difficult determination of the instruction already being non-speculative, especially to capture this uncommon case.

To decrease the false-negative rate—speculative accesses that are actually safe but deemed unsafe due to misses in the table—the SMACT can be made larger or more associative as long as the SMACT latency fits within that of the D-cache and does not introduce delays in the access path. While one may expect to look up the SMACT using the source PC, revoking permissions upon memory free of a destination requires look up using the destination address because only the destination address is available during free unlike speculative accesses where both the source PC and destination addresses are available. Consequently, the SMACT uses an inverted organization of looking up source-destination pairs by accessing using the destination to retrieve the source PC.

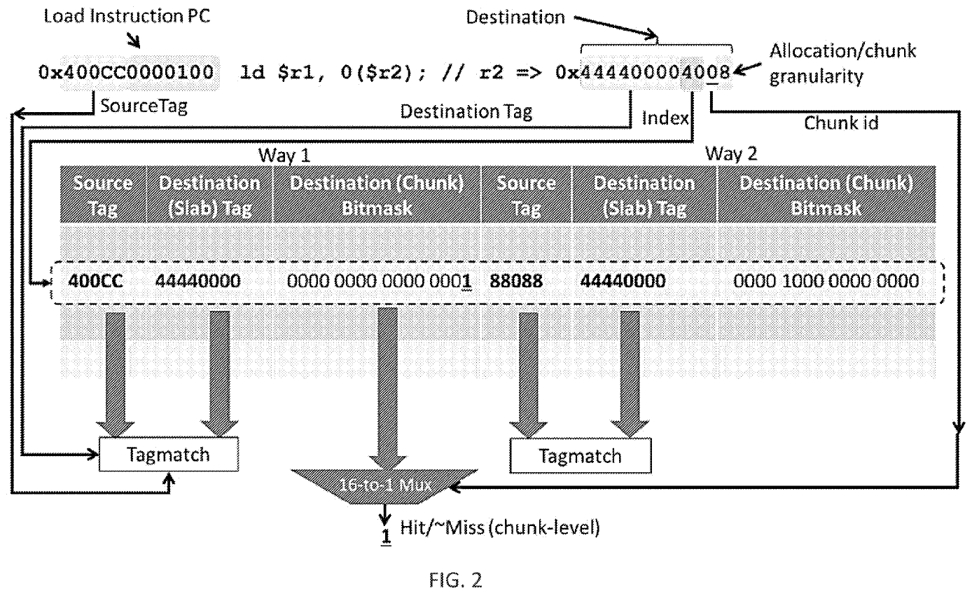

A key difference between the SMACT and a normal cache is that a given address may match in the cache to at most only one frame whereas a given destination may match in the SMACT to one or more entries within the set to which the destination maps. A speculative access may proceed if any of the matching SMACT entries permit the access; the source is disallowed only if none of the matching entries allow the access or if no entry matches. In FIG. 2, which provides a schematic of the SMACT with destination bit mask, the destination matches two entries within the accessed set in the 2-way set associative SMACT but the source matches only one entry. Such replication both reduces the effective capacity of the SMACT and splinters locality in that each source needs to obtain speculative access permissions individually for the same destination and would incur separate misses in the SMACT. Both these issues can be addressed by safely coarsening the source, as discussed further below.

In order to shrink the SMACT, an observation is made that due to locality many upper-order bits of the source or destination across multiple entries would be the same. To exploit this observation, the source or destination fields are split into two levels using bit masks. In the two-level organization, the table entries, which are logically the first level, correspond to coarse-grained slabs (e.g., 256 B). Each first-level entry employs a bit mask at the second level for finer-grained chunks within the slab (e.g., for destination, 16-byte chunks within a 256-B slab result in 16 bits, as shown in FIG. 2). The i^{th} bit in the bit mask being a 1 or 0 signifies the i^{th} chunk within the slab to be permitted or not for speculative access, respectively.

Although space-efficient, the two-level organization still adds bits whereas coarsening, described next, entirely eliminates bits. The source lends itself to heavy coarsening, whereas only limited coarsening is possible for the destination due to safety concerns. As such, the heavily-coarsened source uses flat, one level organization whereas the lightly-coarsened destination uses bit masks, as described below.

To increase the effective size and decrease false-negative rates, the source and destination granularities are coarsened. However, naive coarsening induces potentially unsafe aliases where the speculative access permissions of a source-destination pair would be inherited by the other aliases. As such, the source can be coarsened to a region granularity (e.g., 256 MB as in FIG. 2) if the code and static data from different trust domains within a process are placed at different regions at region-aligned boundaries (e.g., user code, libraries either together or in subsets, browser, and kernel). Any secret non-speculatively accessible by any part of a trust domain's code is accessible non-speculatively by all of the domain's code (i.e., speculative access permission for one source can be inherited by other sources within one trust domain) and needs protection only from other domains' code. Thus, our placement requirement ensures safety for source coarsening. Such coarsening drastically reduces locality splintering and improves effective SMACT capacity by combining multiple sources into one SMACT entry.

Coarsening the destination, however, needs to consider dynamic memory allocation which can arbitrarily interleave allocations for different intra-process trust-domains in a fine-grained manner. Hence, the destination cannot be coarsened to the same extent as the source. As such, we coarsen the destination to the granularity of the minimum dynamic memory allocation size and its alignment (e.g., 16 B as in FIG. 2). Increasing this minimum size for more coarsening, and hence smaller SMACT, may lead to internal fragmentation of memory and poorer cache hierarchy performance due to degraded spatial locality. We increase the 32-B minimum used in some malloc( ) versions to 64 B. We account for the accompanying performance loss due to our malloc-64( ) (around 1% on average).

In our inverted SMACT organization, the heavily-coarsened source uses a flat, one-level representation. For example, for a 48-bit virtual address with source coarsened to 256 MB regions, the first level holds the upper-order 20 bits (see FIG. 2) The lightly-coarsened destination uses a two-level representation based on bit masks for the entries and pointers for the tag. Also, the slabs can be larger (e.g., 4 KB slab for 64 B chunks) without the bit masks becoming unwieldy.

To save area, the well-known BTB often uses partial tags and partial payload (target). Only a few tag bits are enough to achieve highly accurate PC-to-BTB-entry match for prediction. Similarly, the payload contains only enough target bits to index into the I-cache (and the I-TLB) and accurately retrieve the target instruction. For prediction verification, the predicted PC can be constructed using the I-cache's tag bits. However, speculative access control does not permit such arbitrary coarsening of the source-destination pairs. Fortunately, like in the SMACT, the source can be coarsened to a region under the previous constraint that different software components are aligned at the region boundaries. However, the destination remains fine-grained because it is hard to guarantee the absence of gadgets within coarser-grained regions of code.

Whenever the sandbox boundary changes dynamically (e.g., explicitly through memory de-allocation or recompilation, or implicitly through software access-control modification, as discussed later), the stale permissions must be revoked to prevent incorrectly allowing speculative accesses. Because the sandbox boundary changes too infrequently to justify cache coherence-like complexity (e.g., once per 22K-70K instructions in some SPEC benchmarks), we advocate using software to invalidate a multicore's SMACTs (similar to TLB shootdowns by the OS). However, the de-allocation rate is too high for individual revocations which incur high overhead (e.g., 10K cycles) mainly (1) to invoke a handler and (2) to trigger inter-processor interrupts to invoke the handler on all the cores of a multicore, reducing overall throughput. The actual invalidation of a SMACT entry occurs at L1 cache hit speeds (SMACT accesses) and does not impose much overhead over the usual work in free( ). Consequently, we propose to amortize the handler invocation cost by lazily batching several memory frees (our third innovation). Unlike batching TLB shootdowns which raises TLB coherence, TLB consistency, and OS semantics issues (e.g., batching violates POSIX semantics), our batching simply delays freeing of memory without any correctness issues. A performance issue, however, is that delaying the frees increases the memory footprint and decreases locality by forcing distant reuse of the freed memory. Less batching decreases these batching overheads but increases the above handler invocation overhead. Fortunately, frequent freeing in applications, requiring more batching, is typically of small chunks of memory (e.g., 64-128 B). We balance the two overheads via two thresholds based on empirically-observed rate and memory size of frees. Assuming 10 K cycles per handler instance on each core of a 32-core multicore, we empirically find that an instruction throughput overhead of under 1% for our benchmarks (i.e., one invocation per 10 K*32*100=32 M cycles) requires batching up to 25 K frees or 2 MB of to-be-freed memory (the two thresholds). While 2 MB adds negligible memory footprint, we evaluate the batching overhead as provided below.

We modify free( ) to check whether either threshold is exceeded (see Algorithm, below). If not, free( ) simply adds the to-be-freed memory to a pending set. If so, free( ) invokes the handler, passing the set, to revoke the permissions. Then free( ) reclaims the corresponding memory to be re-allocated in the future. The handler invalidates each relevant table entry one by one. Another option is to invalidate the entire table. A corner case that may come to mind is that after a permission is revoked, a core may re-acquire the permission by accessing the freed memory. However, the permission is granted only if the access reaches commit, a non-speculative use-after-free bug which is beyond the scope of SafeBet. In JavaScript, for example, a dynamic down-sizing of an array would not lead to such a bug because the bounds checking would disallow access to the freed memory beyond the new array boundary. Any such access due to mis-speculation of the bounds check would not reach commit to re-acquire the permission.

ALGORITHM Lazy-Free

| 1: | function LAZYFREE(ptr) | |
|---|---|---|
| 2: | freedSize ← freedSize + findAllocSize(ptr) | |
| 3: | count ← count + 1 | [symbol] Track free count |
| 4: | pendingFree[count] ← ptr | [symbol] Append to list |
| 5: | if (count >25,000) OR (freedSize >2M) then | |
| 6: | handler(pendingFree, count) | [symbol] Invoke handler |

| | |
|---|---|
| 7: | end if |
| 8: | end function |

Analogous to freeing of data memory, the code memory can be modified or freed (e.g., dynamic linking or just-in-time (JIT) compiling). Code memory changes affect both the source and destination of the permissions (the source in the SMACT). Considering the SMACT sources, we observe that code modifications usually do not require the existing permissions to change because the rest of the code in the region and its permissions do not change, so it is not meaningful to change the permissions only for the new code within the same region (e.g., reJITing a function). Any new code installed in a new region freshly acquires permissions upon commit, as usual (e.g., a new browser tab). The cases where the new code reuses an existing region (e.g., a new browser tab replacing an old tab) require the existing permissions to be revoked, which involves source-based invalidations whereas all the previously-discussed invalidations have been destination-based. There are two options for source-based invalidations: The handler invalidates either (1) each table entry that matches on the source, or (2) the entire table.

INTEL-SPECIFIC HOMONYM-BASED ATTACKS: INTEL-specific homonym-based attacks exploit lazy TLB checking or speculating past TLB misses. The unsafe transient accesses can be prevented if the SMACT uses physical addresses instead of virtual addresses for the destination. The SMACT would be virtually-indexed and physically-tagged using the destination address, and accessed in parallel to the TLB and cache (i.e., the SMACT lookup critical path remains unchanged). The destination physical tag from the SMACT is checked eagerly against the D-TLB output or its prediction. While D-TLB hits and predictions that are full addresses are straightforward, partial-address predictions choose the best-matching SMACT tag within the accessed SMACT set, effectively providing the predicted full address for the access. If the partial address yields a correct prediction in the original scheme, then the matching tag is also likely to do so. Any incorrect choice still results in an SMACT-permitted access and not a disallowed access, though the predicted address may be incorrect. The source remains virtual to allow coarsening beyond page sizes. Further, the destination tag must include the full physical page number which, fortunately, is not a problem because page-sized destination slabs perform well. Because the destination is not coarsened beyond the page granularity (i.e., the chunks are smaller than a page), there are no challenges with destination coarsening. Physically-tagged structures need not be flushed upon context switches, though TLB shootdowns have to be ap-plied to the physically-tagged SMACT as well. However, malicious virtual machines can update ‘not present’ guest page table entries with forbidden physical addresses to which Intel hardware allows speculative accesses. In this case, the unflushed SMACT would allow a malicious virtual machine to use a victim virtual machine's physically-tagged permissions. This problem can be prevented by flushing the SMACT table upon context switches, disallowing speculation on ‘not present’ page table entries (while allowing other predictions), or adding PIDs to the source address (to prevent the reuse of permissions across virtual machines). Unlike virtually-indexed caches, there are no synonym issues because synonyms can look up different entries in the tables similar to the TLB.

With respect to the context-based dynamic vulnerability discussed above, if a region cannot call any other region's functions then no reuse of permissions is possible across regions whose static PCs are different. Otherwise, static PCs are insufficient. Consider a browser providing an encryption utility using a secret key where the utility is in the browser's region and is used by the tabs, each of which is in a different region. Creating a copy of the utility for each tab (i.e., the static PC of each copy is unique) avoids the sharing across the tabs, but not browser-tab sharing which, unfortunately, cannot be avoided or disallowed. When called legitimately from a tab, the utility would obtain permissions to access the key. The tab can call the utility again a second time to make forbidden accesses to the key using the obtained permissions

One approach to remedy the context-based dynamic vulnerability is to annotate the permissions with the calling contexts to distinguish among the permissions obtained during calls by different regions. However, the two calling contexts in the above example are identical. As such, the only safe option may be to create a unique instance upon every region transition, irrespective of the calling context, to prevent permission reuse across different regions', or even the same region's multiple, dynamic instances (e.g., different library calls by the victim).

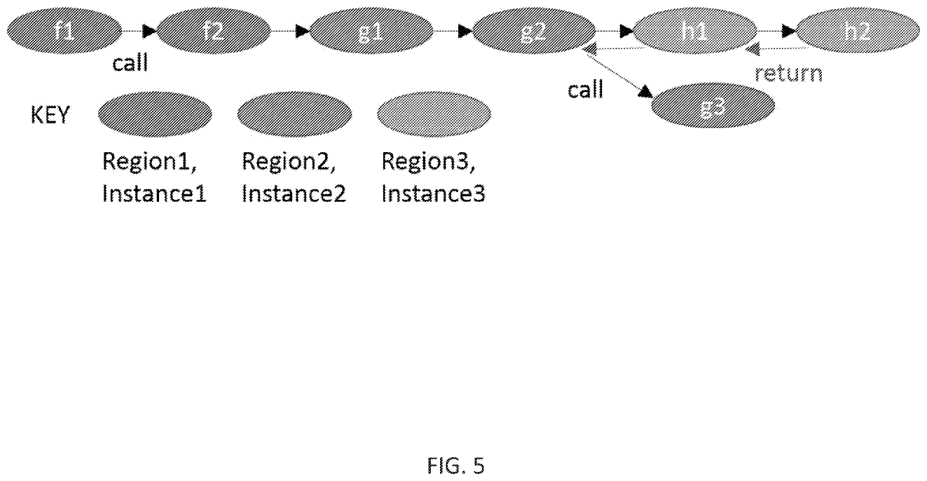

A region R's instance I starts at the first control transfer to a function Fin R from a different region (e.g., Region2's g1 in FIG. 5, where an example schematic of regions with calls and instances is provided). In general, the region-crossing control transfer could be based on function calls, branches, jumps, or returns. The duration of/includes all the calls to and returns from other functions within R until F returns, even if there are intervening calls to and returns from functions in other regions, all of which are excluded from I. In FIG. 5, Instance2 includes g1, g2, and g3, but not Region3's h1 and h2 which are in Instance3. Each instance receives a unique instance identifier, or simply instance. In the above example, a tab cannot read the browser's data (e.g., the key) or the other tabs' data (protected by the SMACT). Each call from a tab to the utility is a separate instance that can read the key but the caller tab cannot read the key or the other tabs' data (protected by the instances).

The unique instances ensure security but degrade performance by disallowing reuse of permissions across instances. That is, every instance must obtain its own permissions, thus splintering locality. Of course, later accesses can proceed speculatively, as before. This splintering of locality is similar to that without source coarsening (discussed herein), but now across multiple instances of the same coarsened source region. To avoid unnecessary splintering in two common cases, we distinguish between the owner region and other visitor regions (e.g., the browser is the owner, and the tabs are visitors). In the case of multiple owners (e.g., browser, guest OS, hypervisor, and host OS), there is a hierarchical and dynamic aspect to owner-visitor relationship (e.g., the browser is the owner for the tabs but a visitor for the guest OS). Fortunately, this aspect does not matter for our purposes as we see below. The owner may provide utilities that a visitor can call (such as the encryption utility example above). We note that in any sandboxing (underlying not only SafeBet but also NDA, Speculative Taint Tracking (STT), and others), the owner is trusted by the visitors and can access any location of any visitor. In the case of one owner, we assume that the loader sets the owner register. Multiple owners can be supported by a few registers or via software convention of loading the owners at a specific address range so hardware can identify (e.g., using upper-order address bits).

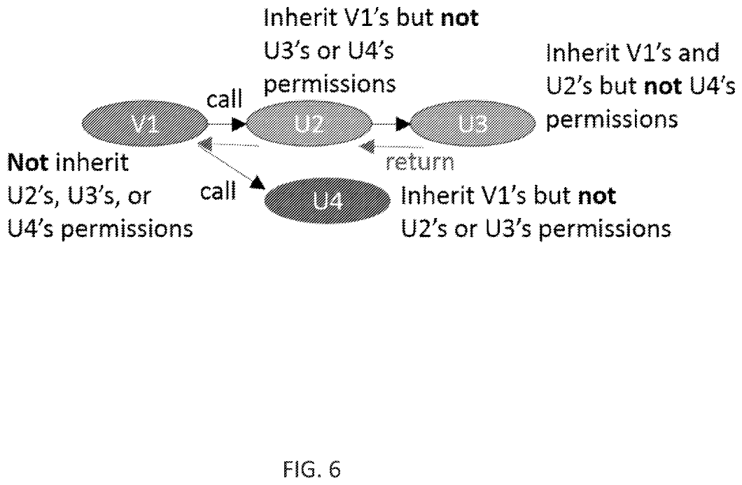

In our first optimization, a callee instance not being able to reuse the caller's permissions causes considerable locality splintering. To address this issue, the trusted owner-provided utility callee instance can inherit and reuse the permissions of its visitor-caller instance, which is a common inter-region transition (e.g., U3 inherits U2's permissions in FIG. 6). This inheritance allows the owner-callee to reuse the visitor-caller's permissions, without modifying the permissions or adding any new permissions. However, this inheritance is strictly asymmetric: the visitor-caller cannot reuse the permissions of the utility-callee upon return; nor can multiple utility-callee instances reuse each other's permissions. In FIGS. 6, V1 and U4, respectively, cannot inherit the permissions of U2, U3, or U4, and U2 or U3. Visitor-to-owner and owner-to-owner inheritance are allowed whereas (a) visitor-to-visitor and (b) owner-to-visitor cases are disallowed (Table II). In owner-to-owner calls, the caller acts as a visitor similar to valid inheritance (e.g., browser making a syscall to the OS); the reverse act is not practical (e.g., the OS does not call a process; and OS signal or browser call-back delivery, respectively, is not a OS-to-process or browser-to-tab call). Thus, multiple owners do not matter for inheritance purposes. In case (a), while it is not meaningful for visitors to provide utilities for each other, EBPF allows one filter to call another via filter chaining. In this case, one visitor should not inherit from another. Case (b), which is the reverse act, is not practical. Allowing inheritance only if the callee is the owner correctly excludes cases (a) and (b).

Second, a return to the caller's instance is another common inter-region transition. Fortunately, the instance is not new and cannot reuse the permissions of its returned callee, its own caller, or any of its own previous instances. Therefore, upon a return, the caller instance could retain its instanceID for later instructions. However, if the above reverse act were to occur (i.e., the owner calls a visitor), a malicious visitor may poison the BTB and register values (not protected by sandboxing) to reuse the owner's permissions via a gadget upon return to the owner; whereas a visitor calling the trusted owner does not have this problem. Consequently, retaining the instanceID upon returning only from the owner correctly excludes the unwanted cases which start a new instance.

SafeBet employs the instance counter to generate unique instances upon region transitions, the instance stack in hardware, to track inter-region calls and returns. Additionally, SafeBet maintains (1) a redundant counter, called the shadow counter, as a safety measure for returns, as explained below; and (2) an owner region register to prevent any inheritance whenever the owner is the caller.

The instance stack is similar to the call stack with a key difference: only the calls or returns that cross regions (i.e., the PC and target are in different regions) push to or pop from the stack. Calls or returns within a region do not modify the stack. A region-crossing call increments the context counter to generate a new context, pushes the target's region and the new context on the stack, and also increments the shadow counter. As per the above discussion on returns, an inter-region return pops the stack. To ensure unique instances, the return does not decrement the instance counter; but does decrement the shadow counter (discussed further below).

However, any call or return, including an inter-region one, is typically fetched under unresolved branch speculation which may later lead to a squash. To avoid repairing the instance stack upon squashes, we push to or pop from the stack only when the call or return reaches commit. The instance increment occurs speculatively at decode, decoupled from the stack operation. In the time window between the fetch and commit, any access from the new instance would not match the instance on the top of the stack (TOS) and waits until commit. This waiting occurs only at inter-region transitions and not within regions. This waiting occurs only at inter-region transitions and not within regions. (Speculatively updating the stack and upon a squash repairing the stack via checkpointing, similar to rename tables, is an option.)

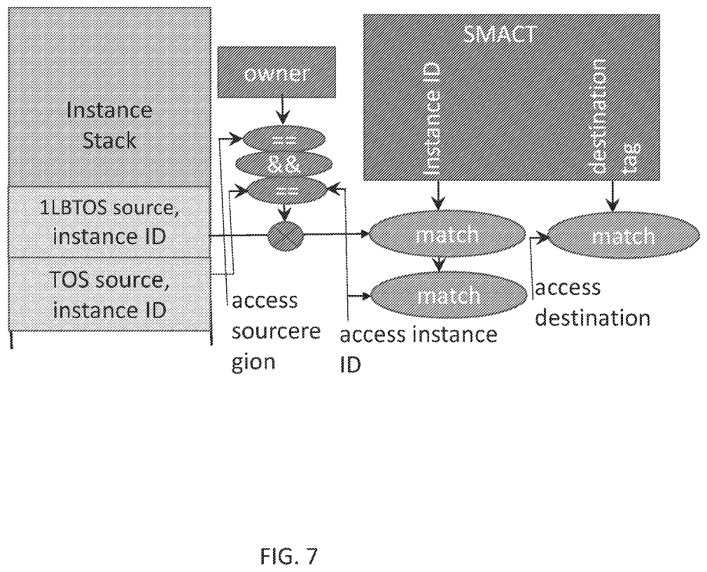

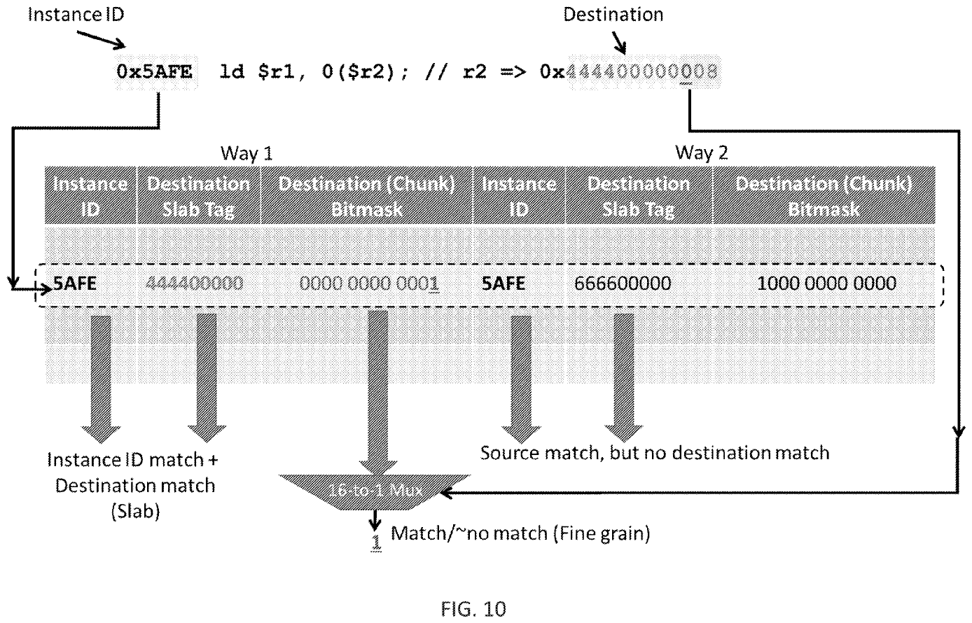

Because the instanceID uniquely identifies the current instance of the source region (i.e., the instanceID subsumes the source region), the SMACT now replaces the source with the instanceID. A SMACT entry now contains the destination tag, the instanceID, and the destination bit mask (see FIG. 10, note the difference with respect to FIG. 2). A SMACT lookup matches the SMACT entry's destination tag against the access's destination tag, and the SMACT entry's instance against the instance of either of the top of stack (TOS) or one line below TOS (1LBTOS), see FIG. 7 which is a schematic exemplifying implementing instances with inheritance. If the TOS is not the owner then any 1LBTOS match is ignored, allowing inheritance only if the callee is the owner, as stated above. The destination bit mask's role remains unchanged.

To handle simultaneous multithreading (SMT), the SMACT may include process identifiers (PIDs) or be privatized for each SMT context to ensure isolation. To handle context switches, the SMACT may include PIDs or be flushed at context switches (a cold SMACT has little performance impact in our context-switch-granularity simulations). Further, we (a) clear the instance stack and (b) either save the context counter leaving intact the SMACT with the previous context annotations or flush the SMACT and reset the context counter. Similar to NDA, we treat special registers (e.g., x86's RDMSR) as special memory destinations. While floating-point registers can also be treated similarly to prevent the Lazy-FP attack, these registers are not virtualized. Hence, PIDs are insufficient for the registers which must be flushed at context switches.

Upon an overflow of the instance counter which does not affect the other cores each of whose instance IDs are from their own instance counters, the SMACT is flushed using software revocation described herein.

In the simple case, where inter-region transfer of code control flow (e.g., shared libraries or gadgets) and data memory locations due to dynamic sandbox boundary changes (e.g., memory de-allocation, re-compilation), and software access-control modification are absent, the static source-destination permissions confine an attacker to its sandbox. Thus, an attacker cannot speculatively access data outside its sandbox in the simple case. Then, the only two options to access such data are: (1) reuse another region's permissions (e.g., the victim's), or (2) reuse the attacker's own permissions that are stale because the attacker's sandbox boundary has changed (i.e., some memory locations have moved from one sandbox to another). These two options cover inter-region transfer of control flow and data memory locations, respectively. In the first option, the attacker cannot directly reuse another region's, say R's, permissions because the source would not match. The only way is for the attacker to transfer control flow to R which must be distinct from the attacker's region. Thus, the attacker must cross at least its own region boundary triggering a new instance which prevents the attacker from reusing R's existing permissions. The only exceptions are (a) an owner, which is trusted, inherits from the caller, and (b) the callee retains its instance upon return from an owner. In the second option of the attacker's sandbox change, SafeBet prevents the attacker from reusing its own stale permissions by revoking the permissions upon such change. We note that such change (a) cannot be done by the attacker and (b) must be done by the sandbox implementation which also performs the revocation without involving the application.

Further, the SMACT holds only non-speculative source-destination addresses; only commits can insert/evict table entries, so a Spectre attack on the SMACT is ruled out. Moreover, the source is obfuscated due to coarsening. Saturating the SMACT or the instance counter may result in denial of service (DOS). However, caches and TLBs, like the SMACT, can leak non-speculative addresses or be subjected to DOS attacks, which NDA, STT, or Speculative Data Oblivious (SDO) execution cannot prevent. As such, the SMACT cannot leak any information different from what caches or TLBs may; in fact, the SMACT holds only addresses and not values unlike caches. Existing mitigations for non-speculation-based attacks apply to SafeBet. Thus, SafeBet's security is similar to that of NDA, STT, or SDO.

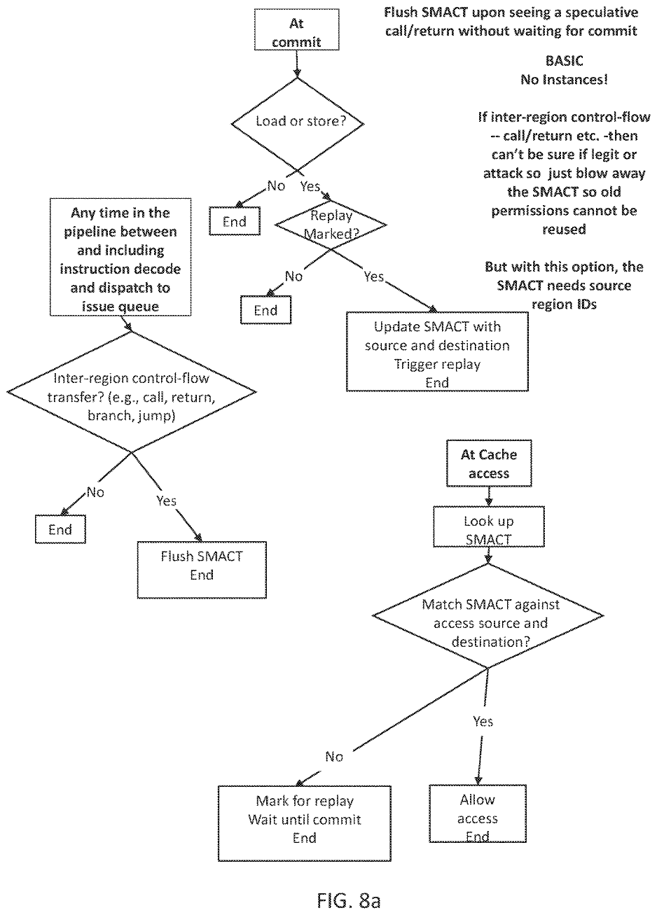

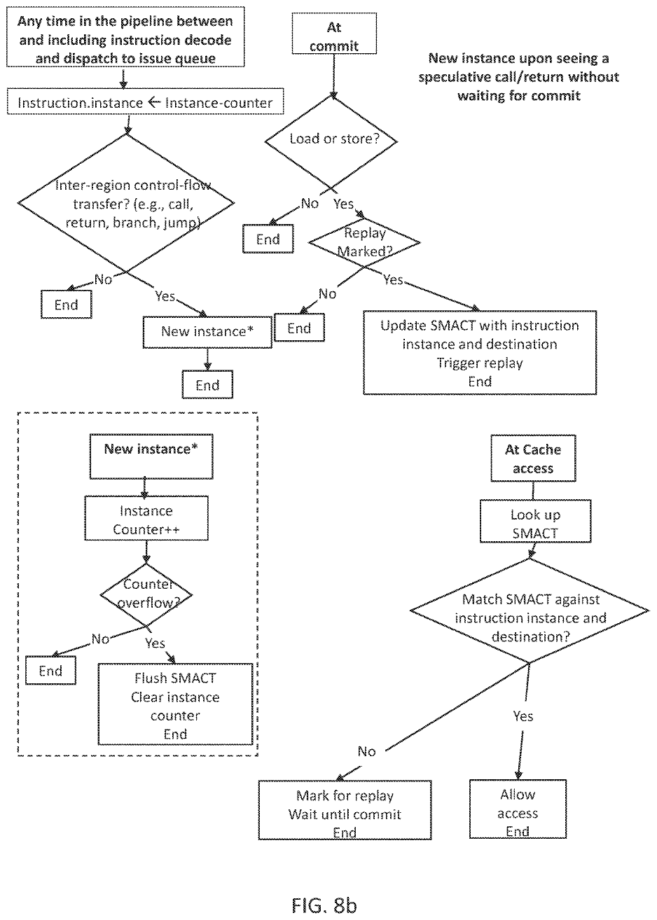

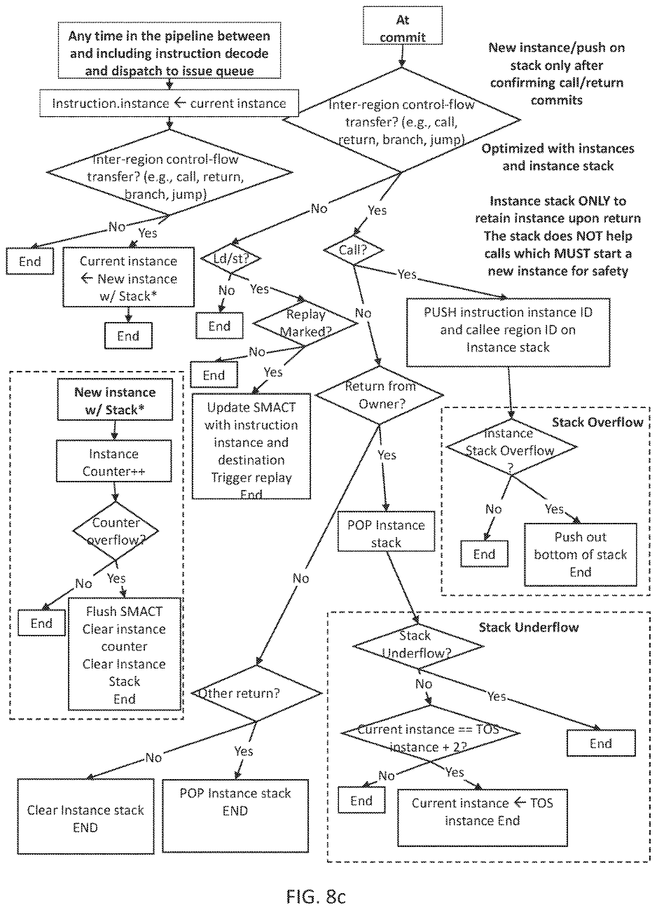

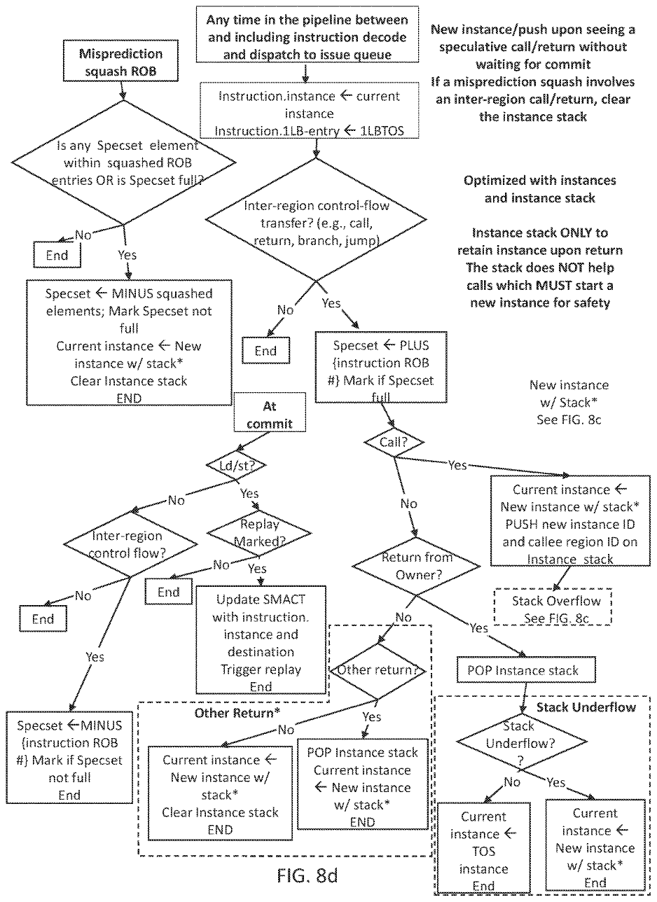

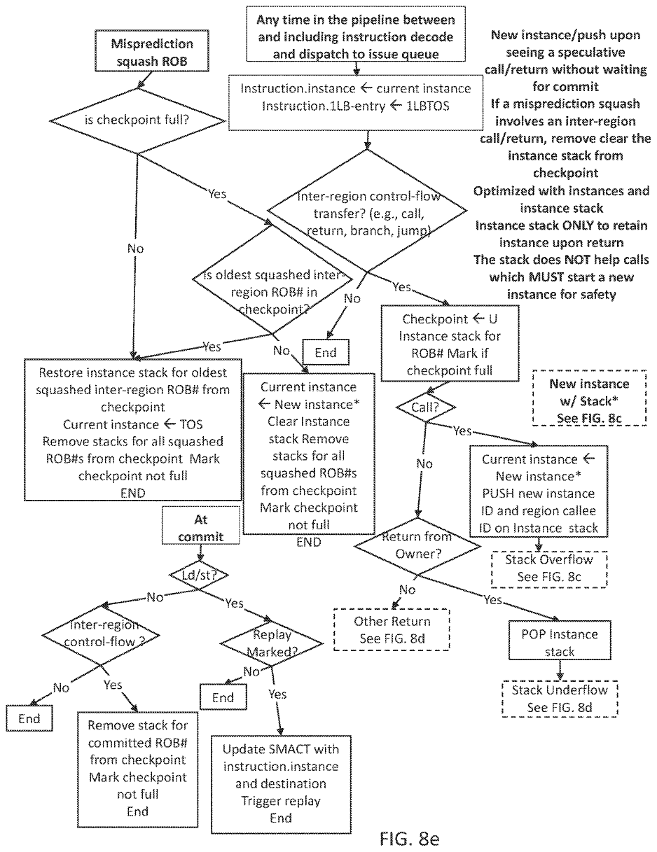

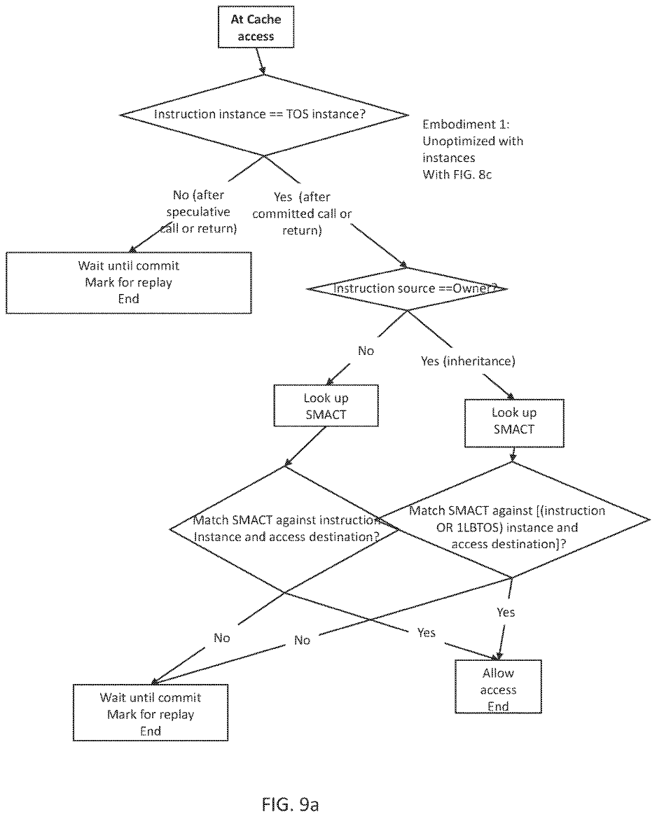

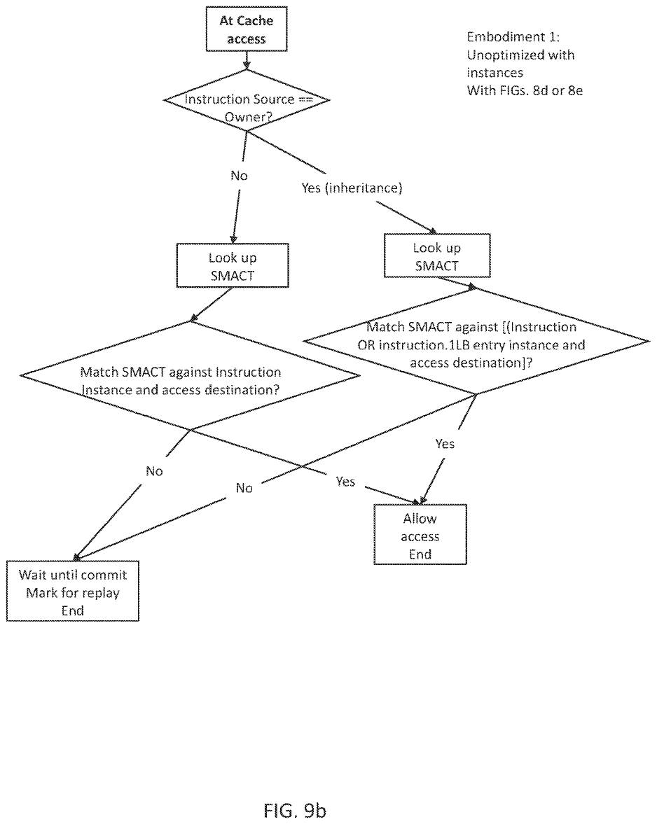

Referring to FIGS. 8a, 8b, 8c, 8d, 8e, 9a, and 9b, flowcharts are provided that depict the operation at various points during execution time, specifically, at some time between decode and dispatch into the issue queue, commit, a misprediction squash, as well as at cache access. As discussed above, commit occurs when the execution of a speculative path has been confirmed/ascertained. In other words, commit occurs when execution sequence in an execution pipeline reaches the head of the ROB. At cache access is when during the execution, a processor must determine which execution paths on which it must proceed. Several different embodiments are depicted and discussed herein.

As referenced above, a region is defined as a grouping of program instructions. For example, a browser (e.g., an Internet browser) occupies one grouping of memory while each of the individual tabs (i.e., sessions within the same browser) occupy a unique grouping. Each of these groupings is viewed as a separate region. A caller-callee relationship can be within a single region, which is typical in program execution, or it can be across different regions. Specifically, in the above-example of browser-tabs, the browser may open a new tab. The tab may call a utility function provided by the browser. In our example, this call constitutes an inter-region call between the tab and the browser. For example, the call may be to use an encryption service offered by the browser.

FIG. 8a is a basic embodiment wherein the SMACT contains source ID and destination ID pairs and upon recognizing an inter-region activity, the SMACT is simply flushed. To avoid a complete destruction of the SMACT upon an inter-region activity, FIG. 8b introduces an instance counter with which an instance is assigned to an inter-region caller-callee activity. In this embodiment, the SMACT is occupied with the instance ID and the destination ID (i.e., no source information is included in the SMACT).

The first embodiment of several embodiments constituting execution scheme according to the present disclosure is shown in FIG. 8a, in which no instance counter is utilized. This is a basic embodiment wherein if the processor identifies an inter-region control-flow transfer (i.e., call, return, branch or jump though only calls and returns are expected in typical software), it simply flushes the SMACT table, which includes source and destination identifiers, to ensure that the called region does not use its own old permissions from when the region was called in the past (i.e., in this embodiment, there is no instance counter). The flushing of the SMACT in this embodiment of FIG. 8a occurs speculatively upon detecting an inter-region control-flow transfer and the detection can occur at any pipeline stage between instruction decode and dispatch, see FIG. 1. At commit if a load is marked for replay, the SMACT is updated with the load's source-destination pair and the replay is triggered. At cache access, the instruction looks up the SMACT using the destination and matches the looked-up SMACT entries against the access's source. If there is a match, then the access is allowed to proceed and the process ends. If there is no match, then the access is marked for replay and waits until commit. In this embodiment, since there is no instance counter, the SMACT only holds source region ID and destination ID as pairs.

The second embodiment shown in FIG. 8b where at any point in the pipeline shown in FIG. 1 between instruction decode and dispatch, every instruction is assigned the instance counter as the instruction's instance and a new instance is created by incrementing the instance counter when an inter-region control-flow transfer is detected. The new instance prevents the instructions in the new region after the control-flow transfer from reusing the region's old permissions in the SMACT (in FIG. 8a the SMACT was flushed to achieve the same prevention). Analogous to FIG. 8a, at commit if a load or store is marked for replay, the SMACT is updated with the instruction's instance and destination pair and the replay is triggered. When incrementing instance counter when an inter-region activity is detected speculatively, the process shown in FIG. 8b determines if the counter has had a counter overflow (i.e., the number of bits assigned to the counter have reached a maximum), if so the SMACT is flushed and the instance counter is cleared. This sub-operation is marked in FIG. 8b as “New instance*. At cache access, the instruction looks up the SMACT using the destination and matches the looked-up SMACT entries against the instruction's instance. If there is a match, then the access is allowed to proceed and the process ends. If there is no match, then the access is marked for replay and waits until commit. In this embodiment, the SMACT holds instance counter and source ID.

The third embodiment is shown in FIG. 8c, in which not only an instance counter (with an instance ID) is utilized but also an instance stack is implemented (the stack is a last-in-first-out array that houses instances and region pairs). The instance stack allows two optimizations whereby if the inter-region activity is between a caller and a callee where the callee is a trusted owner, under meeting certain conditions discussed below, (1) the trusted callee-owner inherits the caller-visitor's permissions (i.e., the callee uses the caller's permissions without changing them or creating new permissions) and (2) the visitor-caller retains its own original instance which allows the visitor-caller to use its own existing permissions upon return from an owner-callee. Similar to the embodiment shown in FIG. 8b, at any point in the pipeline between instruction decode and dispatch, every instruction is assigned the current instance as the instruction's instance and a new instance can be created by incrementing the instance counter and stored in the current instance when an inter-region activity is detected speculatively. While the instances are created speculatively, the instance stack is updated only upon commit to avoid repairing the stack upon a misspeculation. Similar to FIG. 8b, when incrementing instance counter, the process shown in FIG. 8c determines if the counter has had a counter overflow (i.e., the number of bits assigned to the counter have reached a maximum), if so the SMACT is flushed, the instance counter and the stack are cleared. This sub-operation is marked in FIG. 8c as “New instance with stack*.

At commit, the process shown in FIG. 8c first determines if the activity is due to a call (as discussed above, an inter-region activity can be due to several activities: a call from a caller to a callee, a return from a callee to a caller, a branch, a jump, etc.). If the inter-region activity is due to a call (from a caller to a callee), the process shown in FIG. 8c pushes the instruction's instance ID onto an instance stack to enable inheritance if appropriate. If the inter-region activity is not a call, then the process in FIG. 8c determines whether the inter-region activity is due to a return (from a callee back to a caller) and further if the return is from an owner-callee (in the above example, an owner can be a browser, which is a trusted entity). In this case, the caller retains its original instance because the callee is trusted and would not use any malicious addresses or return targets. To do so, the instance stack is popped and as long as the stack is not in the underflow condition (i.e., the instance stack is not empty), and the current instance is two more than the TOS instance (i.e., an instance increment each for the call and the return, and execution is returning to the caller and not to some other caller at a different call depth), the current instance reverts to the TOS instance (i.e., the caller retains its own original instance); however, if the instance stack is empty, then current instance remains unchanged. This sub-operation is marked in FIG. 8c as “Stack Underflow” and is used in subsequent embodiments shown in FIGS. 8d and 8e. If the return is not from a callee-owner, then the process of FIG. 8c determines if the inter-region activity is a return at all (identified as “Other return?”), i.e., from other than a callee-owner; if so, then the instance stacked is popped without any change to the current instance, in which case the caller does not retain its own original instance; and if the answer to “Other return?” is in the negative (i.e., not a call and not a return, but some other reason, e.g., a jump, branch, etc. across regions), the instance stack is not reliable and is thus cleared. Additionally, in FIG. 8c stack when a new instance ID is pushed onto the instance stack, the process in FIG. 8c checks to ensure the instance stack has not had a stack overflow situation (i.e., the array representing the instant stack is full); if it has then the process makes room for the new instance by pushing out an entry from the bottom of the stack. This sub-operation is marked in FIG. 8c as “Stack Overflow” and is used in the subsequent embodiments shown in FIGS. 8d and 8e. Further, similar to the embodiment shown in FIG. 8b, the SMACT is updated at commit when there is a load pr store marked with replay.

The fourth embodiment is shown in FIG. 8d, which is similar to FIG. 8c where the processor at any point in the pipeline shown in FIG. 1 between instruction decode and dispatch assigns the current instance, the 1LBTOS to every instruction's instance and 1LB.entry, respectively (the instruction's instance already captures the current TOS instance), and takes further action when an inter-region activity is detected. While the third embodiment shown in FIG. 8c updates the instance stack only upon commit for simplicity but causes the stack to lag behind the speculative execution frontier preventing (a) speculative loads leading ahead of the stack from exploiting inheritance and (b) speculative inter-region returns leading ahead of the stack from retaining the caller's original instance; the fourth embodiment provided in FIG. 8d updates the instance stack speculatively to remove these shortcoming. This embodiment tracks the instructions that cause inter-region activity by defining a new array Specset. Specifically, the process defines Specset which holds the ROB entry number for the instruction that was responsible for the inter-region activity. Thus when an inter-region activity is detected, similar to FIG. 8c, first the instruction number in the ROB is added to the Specset via a union (shown as “PLUS”). If the Specset becomes full as a result of this union, then a variable associated with the Specset being full, Specset-full, is set. Next, the process similar to FIG. 8c determines if the inter-region activity is due to a call? Thereafter, the process of FIG. 8d follows a similar process down to “Other Return*” as well as “Stack Overflow”, and “Stack Underflow” as shown in FIG. 8c under the query “Call?” but also assigns the current instance appropriately in all cases (i.e., to the TOS if no underflow, or to a new instance in each of the other cases). Specifically, the process referred to as Other Return* which is also utilized in FIG. 8e, is a version of the same process shown in FIG. 8c but in addition placing new instance with stack into the Current instance variable. The process at commit is also similar to what is shown in FIG. 8b, but taking into account the instance stack of FIG. 8c. Specifically, at commit, if the instruction is not a load/store, then the process queries whether the instruction included an inter-region control-flow activity. If so, the process removes the instruction's ROB entry number from the Specset and accordingly sets Specset-full as not full. In this embodiment, if there is a misprediction in the execution pipeline (e.g., during speculative execution, the process determines a speculative path was mispredicted), then the process first squashes the associated instructions in the ROB (i.e., removes those instructions), and then queries as to whether any part of the Specset (i.e., any of the instruction numbers held in the Specset) are within the squashed ROB or alternatively checks to see if Specset is full. If so, the process removes from the Specset the associated instruction numbers from the Specset, mark Specset as not full, increments the instance counter, and clears the instance stack. Thus, in the embodiment shown in FIG. 8d, the processor speculatively adds to Specset upon seeing a speculative inter-region control flow instruction. Each speculative instruction will either be squashed or is committed (one or the other). So at each squash or at each commit the processor removes the squashed or committed inter-region instruction from the Specset to keep the Specset current (shown as “MINUS”). In the embodiment shown in FIG. 8d, the processor avoids clearing the instance stack if no inter-region instruction is squashed and Specset is not full (i.e., the answer to the OR query is NO). In other words, the processor saves the instance stack to enable inheritance, however, the instance stack cannot be saved in the other cases where an inter-region instruction is being squashed because that requires either clearing the stack or repairing the stack as discussed below with regards to the seventh embodiment shown in FIG. 8e. When incrementing instance counter, the process shown in FIG. 8d follows the sub-operation marked in FIG. 8c as “New instance w/Stack*”.

The fifth embodiment is shown in FIG. 8e which is an embodiment that avoids destruction of the instance stack upon a misprediction by repairing the instance stack. To do so, a new array Checkpoint is defined that holds a snapshot (i.e., copy) of the instance stack at the time of every speculative inter-region control-flow transfer is detected. When an inter-region activity is detected, similar to FIG. 8d (i.e., at any point in the pipeline between instruction decode and dispatch), first the instance stack at that time is added to the Checkpoint via a union. If the Checkpoint becomes full as a result of this union, then a variable associated with the Checkpoint being full, Checkpoint-full, is set. Next, the process similar to FIG. 8c determines if the inter-region activity is due to a call. Thereafter, the process of FIG. 8e follows the same process down to “Other Return”, “Stack Overflow”, and “Stack Underflow” as shown in FIG. 8d under the query “Call?” The process at commit is also similar to what is shown in FIG. 8d, but taking into account the Checkpoint. Specifically, at commit, if the instruction is not a load/store, then the process queries whether the control flow included an inter-region activity. If so, the process removes the snapshot stack for the instruction being committed from the Checkpoint and marks the Checkpoint as not full. In this embodiment, if there is a misprediction in the execution pipeline (e.g., during speculative execution, the process determines a speculative path was mispredicted), then the process first squashes the associated instructions in the ROB (i.e., removes those instructions numbers), and then queries as to whether Checkpoint is full. If so, then the process queries whether the oldest squashed inter-region instruction's snapshot stack number is in the Checkpoint. If so or if the Checkpoint is not full, then the process restores the instance stack snapshot for the oldest squashed inter-region ROB entry from the Checkpoint as the instance stack, assigns current instance as the TOS, and removes the stack snapshots for all the squashed ROB entries from the Checkpoint and marks the Checkpoint as not full. If the oldest squashed inter-region ROB entry's instruction stack snapshot is not in the Checkpoint, then the instance counter is incremented and assigned to current instance, the instance stack is cleared, the instance stack snapshots for all the squashed ROB entries are removed from the Checkpoint, and the Checkpoint is marked as not full.

To recap, FIG. 8c is a flowchart of an embodiment which at commit handles inter-region activity by utilizing an instance stack which as discussed below allows an owner-callee to inherit the visitor caller's permissions and a visitor-caller to retain its own instance upon return from an owner-callee; FIG. 8d is a version of the embodiment shown in FIG. 8c which while using the instance stack further allows speculatively inheriting permissions and retaining instance by utilizing an array Specset, however, if the processor recognizes a misprediction, it clears the instance stack; and FIG. 8e is another version of the embodiment shown in FIG. 8c, which while using the instance stack further allows speculatively inheriting permissions and retaining instance by utilizing another array Checkpoint, however, if the processor recognizes a misprediction, Checkpoint is capable of fixing the instance stack.

As discussed with regards to FIGS. 8a and 8b, the processor takes specific actions at cache access. FIG. 9a, provide an embodiment of how to handle at cache access in combination with the embodiment shown in FIG. 8c in which the instance stack for handling inter-region activity is updated at commit) while FIG. 9b provides the at-cache-access embodiment for FIGS. 8d and 8e where the instance stack is updated speculatively.

Referring to FIG. 9a flowchart describing the steps of the method of the present disclosure at cache access are presented. FIG. 9a begins by inquiring whether the instruction's instance is the same as the instance at the top of stack. Because FIG. 8c updates the instance stack at commit, the stack may lag the speculative execution frontier and no for this check means the stack lags the current cache access instruction and yes means the stack has caught up. If no, then the lagging stack cannot be used for inheritance and the lagging stack implies that the inter-region activity that created the instruction's instance has not committed (nor has any later instruction with that instance following the activity). Therefore, the SMACT does not have any permissions with this instance, so that the method does not unnecessarily probe the SMACT and instead stalls the instruction until commit, marks the instruction for replay, and ends. If yes, then the method inquires if the instruction's source region is an owner region (i.e., the stack has caught up and is the current access from an owner?) If yes, then the method allows the owner to inherit using the stack (as the owner cannot be a malicious player). The method looks up the SMACT using the access destination, and inquires whether the looked-up SMACT entries match the instruction's instance or the inherited instance ID at one level below the top of stack (i.e., the instance of the owner's caller). If yes, the method allows the access to proceed and ends. If no, the method waits until commit, marks for replay, and ends. If instruction's source region is not an owner region, then the method looks up the SMACT using the access destination, and matches against the instruction's instance without any inheritance. If there is a match, the method allows the access to proceed and ends. If there is no match, the method waits until commit, marks for replay, and ends.

The embodiment shown in FIG. 9b works in combination with the embodiments shown in FIG. 8d or 8e where the stack is updated speculatively so the stack does not lag the speculative execution frontier like FIG. 8c. This embodiment (FIG. 9b) is similar to the embodiment shown in FIG. 9a, except that at cache access, the process does not have to check if the TOS instance matches the instruction instance (always true in FIG. 9b because the stack does not lag) and immediately inquires whether the instruction source region belongs to an owner. If not the process looks up the SMACT by matching against the instruction's instance. If so, the process allows inheritance by matching against the instruction's instance or the instruction's 1LB.entry's instance. The remainder is the same as that shown in FIG. 9a.

In order to better demonstrate the operations shown in FIG. 8c which works with the embodiment shown in FIG. 9a, the following example is provided. In FIG. 8c embodiment, the instances are created speculatively and the instance stack is updated only upon commit. As discussed above, each instance stack entry contains a pair of instance ID and region ID. FIG. 9a is the cache-access embodiment working with FIG. 8c. In this combination (i.e., FIGS. 8c and 9a), cache access and commit events are intermingled in various times: cache access happens out-of-order, speculatively; while commit happens in program order, non-speculatively. Suppose current execution is in one region, identified as R0, which is a visitor region (i.e., not an owner region, in the prior example this visitor region may be a tab and not the browser). Now assume the instance stack has only one entry=(R0,0) (i.e., bottom of stack (BOS)==top of stack (TOS)==R0 with instance ID=0). And that the current instance is 0. Then suppose the following instructions (e.g., load A1) are fetched in predicted order and placed in the ROB having the associated IDs and go through FIG. 8c flowchart starting at any point between decode and dispatch: 1) load A1: source R0, destination A1, instance 0; 2) inter-region call to owner region R1 (i.e., source R0, target R1, and instance 0) which causes the current instance to be updated with a new instance by incrementing the instance counter; 3) load A2: source R1, destination A2, and instance 1; 4) branch (non-inter-region); 5) inter-region return from source R1 to target region R0 (i.e., source R1, target R0, and instance 1) which causes the current instance to be updated with a new instance by incrementing the instance counter; and 6) load A3: source R0, destination A3 and instance 2. As discussed above, ROB is a buffer that is specific to speculative execution.

When dealing with ROB ID 1 (load A1), the process queries whether instruction's instance (0)==TOS instance (0)), next the process in FIG. 9a checks to see if the TOS region is an owner, which is not in this case, since R0 is not an owner. The process then looks up the SMACT to determine if top of stack instance (i.e., ID 0) and access destination (i.e., A1) have a match with entry in the SMACT (i.e., pairs of instance ID and destination), if so then that match would indicate a legitimate access, the process in FIG. 9a proceeds to allow access; if not, then the instruction is marked for replay and waits until commit. Assume that the load proceeds (i.e., not marked for replay). To better visualize this traversal in FIG. 9a, reference is made to FIG. 13a showing traversal of FIG. 9a based on the above explanation.

Now suppose the branch instruction (ROB ID 4) is executed speculatively. During the execution of this branch, the execution pipeline determines the execution was mispredicted. As a result, according to techniques of speculative execution, known to a person having ordinary skill in the art, the later instructions in the ROB are squashed (these include ROB ID 5-inter-region return from source R1 to target region R0; and ROB ID 6-load A3: source R0 and destination).

Now ROB ID 3 (load A2: source R1, destination A2, and instance 1), executes which returns us back to FIG. 9a. At this point this load instruction (instance 1) is ahead of the stack (TOS instance is 0) since the inter-region call has not reached commit yet. Thus, the TOS is still pointing to instance 0. In FIG. 9a, the first query of whether instruction's instance (i.e., 1) is the same as TOS instance (i.e., 0), returns in the negative so the load is marked for replay and waits till commit.

At this point suppose ROB ID 1 (load A1: source R0, destination A1, and instance 0) reaches commit. We return to FIG. 8c where there is no action to be taken (because the load is not marked for replay). (The ROB commits the load.)

Next, ROB ID 2 which is an inter-region call to region R1 owner (i.e., source R0 and target R1) commits which FIG. 8c is relevant. The traversal of this instruction is shown in FIG. 13b, since this call constitutes an inter-region activity. Traversing the flowchart of FIG. 8c, the answer to the first query (Inter-region control-flow transfer?) is Yes; the answer to the second query (Call?) is Yes; and follows to PUSH instruction's instance ID and callee region ID (i.e., call target R1) on instance stack, so now the instance stack has R0-0; R1-1 as the two pairs with TOS being occupied by R1.

Next ROB ID 3 (load A2: source R1, destination A2, and instance 1) reaches commit for which we return to FIG. 8c. Because the load is marked for replay, it updates the SMACT with (instance1, destination A2) pair and replays. In FIG. 9a, the instruction's instance (1)==TOS instance (1), the source R1 is owner, the SMACT is looked up using destination A2 to match against either instruction's instance (1) or 1LBTOS instance (0). This load updated the SMACT with (instance 1, destination A2) which now matches. The load is allowed to proceed (and eventually commits).

To illustrate the combination of FIGS. 8d and 9b, consider the following example of instructions fetched in predicted order and placed in the ROB having the associated IDs and the current instance is 0 and region is R0 which is a visitor: 1) load A1: source R0, destination A1; 2) inter-region call to owner region R1 (i.e., source R0, target R1); 3) load A2: source R1, destination A2; 4) branch (non-inter-region); 5) inter-region return from owner R1 to visitor R0 (source R1, target R0); 6) branch (non-inter-region); 7) load A3: source R1, and destination A3. Assume the stack is (R0,0) and Specset is empty and can hold 5 ROB IDs. As explained below, ROB ID4 branch mispredicts and after the misprediction detection, fetch restarts on the correct path and reuses ROB ID 5 onwards. The next fetched load A4: source R1 and destination A4 reuses ROB ID5.

When ROB ID 1 load A1 (source R0, destination A1) is fetched and processed at any point between decode and dispatch, the instruction is assigned the instance 0 and 1LB.entry as NULL. ROB ID2 inter-region call to owner R1 places ROB ID2 in Specset which is not full and creates a new instance 1 and assigns current instance to be 1, pushes the new instance and target region (R1, 1) on the stack without overflow (stack now holds (R0,0) and (R1, 1) which is TOS). ROB ID 3 load A2 is assigned instance 1 (source R1, destination A2, instance 1) and 1LB.entry as (R1,1). ROB ID 4 branch (non-inter-region) does not change anything. ROB ID 5 is an inter-region return from owner R1 to R0 which places ROB ID 5 in Specset which is not full and pops the stack (now only (R0,0)) assigning current instance to be 0. ROB ID 6 branch (non-inter-region) does not change anything. ROB ID 7 load A3 is assigned instance 0 (source R0, destination A3, instance 0) and 1LB.entry as NULL.

When ROB ID 1 Load A1 executes (FIG. 9b), the instruction source is R0 which is not an owner. Thus, the load looks up the SMACT using destination A1 to match against the instruction's instance==0. Like Load A1 in the previous example for FIG. 9a, we assume that the current load is allowed to proceed. Now, ROB ID 6 branch executes and detects a misprediction causing squash of ROB ID7 load A3. In FIG. 8d misprediction flowchart, Specset holds ROB ID3 and ROB ID5 which are not squashed and the Specset is not full. Thus, the misprediction does not affect the instance stack or Specset. Now ROB ID 4 branch executes and detects a misprediction causing squash of ROB ID 5 return. In FIG. 8d misprediction flowchart, Specset holds ROB ID3 and ROB ID5 so that ROB ID 5 (the oldest squashed ROB ID) is removed from Specset, a new instance 2 is created and the instance stack is cleared (made NULL). Recall from above that after this misprediction, fetch restarts at load A4 for which ROB ID5 is reused. In FIG. 8d, reused ROB ID 5 load A4 is assigned instance 1, and 1LB.entry are NULL (the stack was cleared by ROB ID4 branch's misprediction).

Now, ROB ID 3 load A2 executes (FIG. 9b), the instruction source is R1 which is an owner. The load looks up the SMACT using the destination A2 to match against the instruction's instance (1) or the instruction's 1LB entry's instance (0). Thus, load A2 can exploit inheritance and proceed if either instance matches the looked-up SMACT entries. Now, the reused ROB ID 5 load A4 executes (FIG. 9b), the instruction source is R1 which is an owner. The load looks up the SMACT using the destination A4 to match against the instruction's instance (1) or the instruction's 1LB entry's instance (NULL). So the load loses the opportunity to inherit from its caller visitor R0. So the load can match only against its own instance

For the same example with FIGS. 8e and 9b assume the stack is (R0,0) and Checkpoint is empty and can hold 5 stack snapshots. When ROB ID 1 load A1 (source R0, destination A1) is fetched and processed at any point between decode and dispatch, the instruction is assigned the instance 0 and 1LB.entry as NULL. ROB ID2 inter-region call to owner R1 places a stack snapshot (R0,0) for ROB ID2 in Checkpoint which is not full and creates a new instance 1 and assigns current instance to be 1, pushes the new instance and target region (R1, 1) on the stack without overflow (stack now holds (R0,0) and (R1, 1) which is TOS). ROB ID 3 load A2 is assigned instance 1 (source R1, destination A2, instance 1) and 1LB.entry as (R1,1). ROB ID 4 branch (non-inter-region) does not change anything. ROB ID 5 is an inter-region return from owner R1 to R0 which places a stack snapshot ((R0,0) and (R1, 1) which is TOS in the snapshot) for ROB ID5 in Checkpoint which is not full and pops the stack assigning current instance to be 0. ROB ID 6 branch (non-inter-region) does not change anything. ROB ID 7 load A3 is assigned instance 0 (source R0, destination A3, instance 0) and 1LB.entry as NULL. As before, ROB ID4 branch mispredicts and after the misprediction detection, fetch restarts on the correct path and reuses ROB ID 5 onwards. The next fetched load A4: source R1 and destination A4 reuses ROB ID5.

When ROB ID 1 Load A1 executes (FIG. 9b), the instruction source is R0 which is not an owner. Thus, the load looks up the SMACT using destination A1 to match against the instruction's instance==0. Like Load A1 in the previous example for FIG. 9a, we assume that the current load is allowed to proceed. Now, ROB ID 6 branch executes and detects a misprediction causing squash of ROB ID7 load A3. In FIG. 8e misprediction flowchart, Checkpoint holds ROB ID3 and ROB ID5 which are not squashed and the Checkpoint is not full. Thus, the misprediction does not affect the instance stack or Checkpoint. Now ROB ID 4 branch executes and detects a misprediction causing squash of ROB ID 5 return. In FIG. 8e misprediction flowchart, Checkpoint holds ROB ID3 and ROB ID5 so that ROB ID 5 (the oldest squashed ROB ID) stack snapshot (R0,0) and (R1,1) is used to restore the instance stack and is removed from Checkpoint, and current instance is assigned to the restored instance stack TOS. Recall from above that after this misprediction, fetch restarts at load A4 for which ROB ID5 is reused. In FIG. 8d, reused ROB ID 5 load A4 is assigned instance 1, and 1LB.entry instance is 0 (the stack was restored after ROB ID4 branch's misprediction).

Now, ROB ID 3 load A2 executes (FIG. 9b), the instruction source is R1 which is an owner. The load looks up the SMACT using the destination A2 to match against the instruction's instance (1) or the instruction's 1LB entry's instance (0). Thus, load A2 can exploit inheritance and proceed if either instance matches the looked-up SMACT entries. Now, the reused ROB ID 5 load A4 executes (FIG. 9b), the instruction source is R1 which is an owner. The load looks up the SMACT using the destination A4 to match against the instruction's instance (1) or the instruction's 1LB entry's instance (0). Unlike load A4 in the example for FIG. 8d, here load A4 can inherit from its caller visitor R0 and proceed if either instance matches the looked-up SMACT entries.

Those having ordinary skill in the art will recognize that numerous modifications can be made to the specific implementations described above. The implementations should not be limited to the particular limitations described. Other implementations may be possible.

1. A method of verifying the safety of a speculative instruction, comprising:
a processor speculatively arriving at execution of an instruction, the instruction associated with i) a source representing a range of source virtual or physical memory addresses holding the instruction to be executed, and ii) a destination representing a ranges of destination virtual or physical memory addresses holding data of which one or more addresses are to be loaded onto a register with execution of the instruction in the source, the source and destination representing a pair of information (PAIR);
during instruction execution checking the PAIR against one or more memory tables associated with previous combinations of the PAIR that have successfully cleared as non-speculative,
maintaining the one or more tables in a safe state,
if the speculation of the source instruction clears the checking the PAIR step as safe, then allowing the execution of the speculative instruction to proceed, and
if the speculation of the source instruction does not clear the checking as safe, then execution of the speculative instruction is delayed until such execution becomes non-speculative.

2. The method of claim 1, wherein the PAIR in the one or more tables includes source and destination identifiers.

3. The method of claim 2, wherein the instruction in the source includes a load instruction.

4. The method of claim 1, wherein the source represents a first region.

5. The method of claim 3, wherein the destination represents a second range of virtual or physical addresses.

6. The method of claim 2, wherein the step of maintaining the one or more tables in the safe state includes clearing all entries in the one or more tables whenever a speculative inter-region control-flow transfer instruction is encountered.

7. The method of claim 6, wherein the inter-region control transfer instruction includes one or more of a branch, jump, call, return instruction that starts in the first region and transfers control to the second region by changing a program counter.

8. The method of claim 2, when the execution of the speculative instruction becomes non-speculative, the one or more tables are updated to include the PAIR as having successfully cleared as non-speculative source-destination two-tuples.

9. The method of claim 1, wherein an instance identifier is associated with the instruction and the one or more tables include instance identifier-destination ID two-tuples.

10. The method of claim 9, wherein the instruction includes a load instruction.

11. The method of claim 9, wherein the source represents a first region.

12. The method of claim 11, wherein the destination represents a second range of virtual or physical addresses.

13. The method of claim 9, wherein the step of maintaining the one or more tables in the safe state includes assigning a value associated with an instance counter to an instruction instance variable followed by incrementing the instance counter whenever a speculative inter-region control transfer instruction is encountered

14. The method of claim 13, wherein the inter-region control transfer instruction includes one or more of a branch, jump, call, return instruction that starts in the first region and transfers control to the second region by changing a program counter.

15. The method of claim 9, when the execution of the speculative instruction becomes non-speculative, the one or more tables are updated to include the instance identifier-destination two-tuples as having successfully cleared as non-speculative.

16. The method of claim 9, wherein an instance stack is pushed with the instance identifier of an inter-region call instruction upon an associated commit and the instance stack is popped when an inter-region return instruction commits, wherein an inter-region control transfer instruction includes one or more of a branch, jump, call, return instruction that starts in the first region and transfers control to the second region by changing a program counter.

17. The method of claim 16, wherein the step of maintaining the one or more tables in the safe state includes assigning a current instance variable to an instruction instance variable followed by incrementing an instance counter whenever a speculative inter-region control transfer instruction is encountered and assigning the instance counter to the current instance variable.

18. The method of claim 16, wherein i) an instruction of a callee, which is an owner, and ii) the instruction's instance identifier matches that on the instance stack at a top of stack (TOS), the instruction inherits the associated caller's instance identifier-destination ID two-tuples in the one or more tables by using the caller's instance identifier on the instance stack at one level below the top of stack (1LBTOS).

19. The method of claim 16, wherein a caller's instructions, upon execution returning from a callee which is an owner, retain the caller's own previous instance identifier on the instance stack by first popping the instance stack for the return and then assigning the current instance variable to top of stack (TOS).

20. The method of claim 16, when the execution of the speculative instruction becomes non-speculative, the one or more tables are updated to include the instruction's instance identifier-destination two-tuples as having successfully cleared as non-speculative.

21. The method of claim 9, wherein i) when a speculative inter-region call instruction is encountered, an instance counter is incremented and assigned to a current instance variable which is then pushed on an instance stack, and ii) when a speculative inter-region return instruction is encountered, the instance stack is popped and top of stack (TOS) is assigned to the current instance variable, wherein an inter-region control transfer instruction includes one or more of a branch, jump, call, return instruction that starts in a first region and transfers control to a second region by changing a program counter.

22. The method of claim 21, wherein the step of maintaining the one or more tables in the safe state includes assigning the current instance variable to an instruction instance variable followed by incrementing the instance counter whenever a speculative inter-region control transfer instruction is encountered and assigning the instance counter to the current instance variable.

23. The method of claim 22, wherein a set of inter-region control-flow transfer instructions' identifiers associated with each such instruction's reorder buffer entry (Specset) is maintained in hardware by i) inserting a reorder buffer identifier into the Specset upon encountering such a speculative instruction and ii) deleting the reorder buffer identifier when the instruction either commits or is squashed due to a misspeculation.

24. The method of claim 23, wherein upon a misspeculation squash, if any of the reorder buffer identifiers associated with the squashed instructions is in the Specset then the instance stack is cleared and the instance counter is incremented and is assigned to the current instance variable.

25. The method of claim 22, wherein i) an instruction of a callee which is an owner and ii) the instruction's instance identifier matches that on the instance stack TOS, the instruction inherits the associated caller's instance identifier-destination ID two-tuples in the one or more tables using the caller's instance identifier on the instance stack at one level below top of stack (1LBTOS).

26. The method of claim 22, when execution returns from a callee which is an owner, a caller retains the caller's own previous instance identifier on the instance stack by first popping the instance stack upon the return and then assigning the current instance variable to the TOS.

27. The method of claim 22, when the execution of the speculative instruction becomes non-speculative, the one or more tables are updated to include the instruction instance identifier-destination two-tuples as having successfully cleared as non-speculative.

28. The method of claim 22, wherein a set of snapshots (copies) of the instance stack at various points in time of execution (Checkpoints) is maintained in hardware by i) inserting the snapshots into Checkpoint upon encountering a speculative inter-region control-flow transfer instruction and associating the snapshot with the reorder buffer entry number of the instruction, and ii) deleting the associated snapshot when the instruction either commits or is squashed due to a misspeculation.

29. The method of claim 28, wherein upon a misspeculation squash, i) if the oldest squashed reorder buffer entry has an associated snapshot in the Checkpoint, then the instance stack is overwritten with (restored by) the snapshot and the current instance variable is set to the restored TOS, and ii) If not, the instance stack is cleared, and the instance counter is incremented and assigned to the current instance variable.

30. The method of claim 28, wherein i) an instruction of a callee which is an owner, and ii) the instruction's instance identifier matches that on the instance stack TOS, the instruction inherits the associated caller's instance identifier-destination ID two-tuples in the one or more tables by using the caller's instance identifier on the instance stack at one level below top of stack (1LBTOS).

31. The method of claim 28, wherein a caller's instructions, upon execution returning from a callee which is an owner, retain the caller's own previous instance identifier on the instance stack by first popping the instance stack upon the return and then assigning the current instance variable to the TOS.

32. The method of claim 28, when the execution of the speculative instruction becomes non-speculative, the one or more tables are updated to include the instruction instance identifier-destination two-tuples as having successfully cleared as non-speculative.
